(19) United States
(12) Patent Application Publication
(10) Pub. No.: US 2014/0040059 A1
(43) Pub. Date: Feb. 6, 2014

(54) SYSTEMS AND METHODS FOR PRESENTING AND DELIVERING DIGITAL GIFTS ONLINE

(71) Applicant: DELIGHTFULLY INC., Cambridge, MA (US)

(72) Inventors: JAMES BARABAS, Boston, MA (US); Gina Luciano, Boston, MA (US); Jason Shin, Cambridge, MA (US)

(73) Assignee: Delightfully Inc., Cambridge, MA (US)

(21) Appl. No.: 13/840,392

(22) Filed: Mar. 15, 2013

Related U.S. Application Data
(60) Provisional application No. 61/677,947, filed on Jul. 31, 2012.

(51) Int. Cl. G06Q 30/06

(52) U.S. Cl. CPC G06Q 30/0601
USPC 705/26.1

(57) ABSTRACT

Systems and methods for online digital gift delivery include receiving from a gift sender a request to deliver a digital gift to a gift recipient. In response to instructions received from the gift sender via a user interface provided to the gift sender responsive to receiving the request, a digital gift container including a digital gift presentation and an indication of the digital gift is generated. The digital gift presentation is configured to display a customized arrangement of data content objects and configured to reveal the indication of the digital gift responsive to a gift presentation policy specifying one or more conditions for revealing the indication. The gift recipient is then provided access to the digital gift container. The indication of the digital gift is revealed in response to determining that one or more conditions of the gift presentation policy have been met.

### CROSS-REFERENCE TO RELATED APPLICATIONS

This patent application claims the benefit of and priority to U.S. Provisional Patent Application No. 61/677,947, filed on Jul. 31, 2012 and entitled “Systems and Methods for Presenting and Delivering Digital Gifts Online”, which is incorporated herein by reference in its entirety for all purposes.

### BACKGROUND

In the tangible world, people exchange physical gifts. Oftentimes, these gifts are gift wrapped to enhance the experience of gift giving and gift receiving. For instance, people often wrap gifts with paper and ribbon. In doing so, they create a special experience for the recipient of their gift, an experience in which the recipient does not know what the gift is and has to do something—untie the bow and tear the paper, for example—to receive the gift. In wrapping the gift, the gift giver shows the recipient that the giver has spent time and effort to create the unwrapping experience. Paper gift-wrapping shows thoughtfulness because it shows effort. However, paper gift wrapping does not work for digital gifts delivered online.

### SUMMARY

The systems, methods and devices of the disclosure each have several innovative aspects directed towards online digital gift presentation and delivery Innovative aspects of the subject matter described in this disclosure can be implemented to provide an interactive platform through which a gift sender can present a digital gift to a gift recipient online. In this way, a gift sender can create custom, personalized gift presentations to the gift recipient enhancing the overall experience of gift giving and receiving.

According to one aspect of the disclosure, a digital gift presentation and delivery system provides a user interface through which a gift sender can create a gift presentation for a digital gift. The gift presentation and delivery system includes a gift presentation object configured to create a gift presentation corresponding to a digital gift. The gift presentation and delivery system also includes a gift access object configured to provide the gift recipient access to the gift. In some implementations, the gift access object may be configured to provide access to the gift upon meeting certain conditions. In some implementations, the conditions may be based on time, location, remote communication between the gift recipient and the gift sender, actions predefined by the gift sender, or any other pre-defined action. For instance, the actions can include completing a game, solving a puzzle, sliding images on the screen, entering a pass code, taking a picture, making gestures on a touch screen, amongst others.

In some implementations, the gift access object may be configured to provide the gift recipient access to the gift if the gift recipient performs actions pre-defined by another user, such as the gift sender. More generally, a first user may be configured to gain access to content upon executing pre-defined actions that are defined by another user. In some implementations, the pre-defined actions may be defined such that they are agnostic to various types of computing devices, such as laptops, desktops, tablets, smartphones, amongst others.

In some implementations, the gift presentation object may be configured to receive data content and input from the gift sender. In some implementations, the gift presentation object may receive media content, such as images, video, or audio content from the gift sender. In some implementations, the gift presentation object may receive additional information from the gift sender, such as conditions that have to be met before a gift can be accessed by the gift recipient. In some implementations, the gift presentation object is configured to communicate with a gift provider, such as an online retailer or any other entity that can provide a gift to be presented.

In some implementations, the gift presentation and delivery system can include a gift notification object that is configured to notify the gift recipient of a pending gift. The gift notification object may be configured to send an email, text message, notification on a native application or a web-based application, or any other notification that is configured to notify the gift recipient of a pending gift.

In some implementations, the gift presentation and delivery system can be configured to communicate with one or more other components of a computing device. For instance, the gift presentation and delivery system may be configured to cause a picture to be taken, a phone call to be made, a video messaging session to take place, amongst others.

In some implementations, the gift presentation and delivery system is configured to communicate with e-commerce checkout systems to generate a gift container. In some implementations, the gift container includes gift sender information, gift recipient information, the gift presentation, the gift access instructions, and the gift itself. In some implementations, one or more of the items included in the gift container are received from the e-commerce checkout system. In some implementations, the e-commerce checkout system may be an online retailer, a payment processing site, an online shopping cart, amongst others. In some implementations, the gift presentation and delivery system includes a gift purchasing module configured to receive payment information from a user and to execute a business transaction based on the payment information received from the user. In some implementations, the gift purchasing module may also include an online store front through which users can select gifts for purchase. In some implementations, the online store front may be configured to allow a user to select items as gifts from other online e-commerce platforms, including online retailers.

According to yet another aspect, a method for online digital gift delivery includes receiving from a gift sender a request to deliver a digital gift to a gift recipient. In response to instructions received from the gift sender via a user interface provided to the gift sender responsive to receiving the request, a digital gift container including a digital gift presentation and an indication of the digital gift is generated. The digital gift presentation is configured to display a customized arrangement of data content objects and configured to reveal the indication of the digital gift responsive to a gift presentation policy specifying one or more conditions for revealing the indication. The gift recipient is then provided access to the digital gift container. The indication of the digital gift is revealed in response to determining that one or more conditions of the gift presentation policy have been met.

In some implementations, the indication of the digital gift comprises providing the digital gift. In some implementations, the digital gift container is provided to the gift recipient. In some implementations, a link to the digital gift container is provided to the gift recipient and in response to the gift recipient accessing the link, the gift recipient is provided to a user interface that presents the digital gift presentation to the user.

In some implementations, the gift presentation policy specifies at least one of an event-based condition or an activity-based condition, the event-based condition configured to be met when a particular event occurs and the activity-based condition configured to be met when a particular action is performed.

In some implementations, determining that one or more conditions of the gift presentation policy have been met includes determining that an event-based condition has been met. In some implementations, an indication of an action that matches an action listed as a condition of the gift presentation policy is received from the gift recipient. In some implementations, the gift presentation policy includes one or more conditions defined by the gift sender.

In some implementations, the gift recipient is provided access to the digital gift container responsive to receiving a request to access the digital gift container from a user device of the gift recipient.

In some implementations, a device type of the user device through which the gift recipient is requesting access is identified. The digital gift container is formatted to a format compatible for display with the user device. The gift recipient is then provided access to the formatted digital gift container.

In some implementations, at least one action of the gift recipient is identified responsive to providing the indication of the digital gift. The action is identified as an indication of approval of the digital gift and in response to identifying the action as an indication of approval, suggestions of digital gifts similar to the digital gift to one or more gift senders seeking to send a digital gift to the gift recipient are provided.

According to yet another aspect, a digital gift presentation system includes a digital gift presentation device that is configured to receive from a gift sender a request to deliver a digital gift to a gift recipient. In response to instructions received from the gift sender via a user interface provided to the gift sender responsive to receiving the request, a digital gift container including a digital gift presentation and an indication of the digital gift is generated. The digital gift presentation is configured to display a customized arrangement of data content objects and configured to reveal the indication of the digital gift responsive to a gift presentation policy specifying one or more conditions for revealing the indication. The gift recipient is then provided access to the digital gift container. The indication of the digital gift is revealed in response to determining that one or more conditions of the gift presentation policy have been met.

In some implementations, the gift presentation policy specifies at least one of an event-based condition or an activity-based condition. The event-based condition is configured to be met when a particular event occurs and the activity-based condition is configured to be met when a particular action is performed.

In some implementations, the gift presentation policy includes one or more conditions defined by the gift sender.

In some implementations, the device is further configured to identify a device type of the user device through which the gift recipient is requesting access, format the digital gift container to a format compatible for display with the user device; and provide the gift recipient access to the formatted digital gift container.

In some implementations, the device is configured to receive a request to deliver a digital gift to a gift recipient via a digital gift provider interfacing between the gift sender and the device.

According to yet another aspect, a method for online digital gift delivery includes a device receiving a request to deliver a digital gift to a gift recipient from a gift sender. The device generates a digital gift container including a digital gift presentation and an indication of the digital gift in response to instructions received from the gift sender via a user interface provided to the gift sender responsive to receiving the request. The interactive digital gift presentation configured to be displayed as an arrangement of data content objects, respond to one or more actions taken on the data content objects by the gift sender, and reveal the indication of the digital gift responsive to a gift presentation policy specifying one or more conditions for revealing the indication. The gift presentation policy is defined by the gift recipient. The gift recipient is provided access to the digital gift container; and the indication of the digital gift is revealed via the digital gift container in response to determining that one or more conditions of the gift presentation policy have been met.

In some implementations, a device type of the user device through which the gift recipient is requesting access is identified. The digital gift container is formatted to a format compatible for display with the user device. Then, the gift recipient is provided access to the formatted digital gift container.

### BRIEF DESCRIPTION OF THE DRAWINGS

FIG. 1 shows an example block diagram of an environment for online digital gift presentation and delivery.

FIG. 2 shows a block diagram of an embodiment of an online digital gift presentation and delivery system.

FIG. 3 shows a block diagram of an embodiment of a gift container.

FIG. 4 shows a flow chart of an embodiment of a process corresponding to the environment of FIG. 1.

FIG. 5A shows a diagram of an embodiment of a work flow of data between parties of the environment associated with FIG. 1.

FIG. 5B shows a diagram of an embodiment of a work flow of data between parties of the environment associated with FIG. 1.

FIG. 6A shows a flow diagram of an embodiment of a method for online digital gift delivery.

FIGS. 6B-C show embodiments of user interfaces and functionality corresponding to the process flow diagram depicted in FIG. 6A.

FIGS. 7A-E show embodiments of a user interface for generating a digital gift presentation.

FIG. 8 shows a flow chart of an embodiment of a process corresponding to the environment of FIG. 1.

### DETAILED DESCRIPTION

The systems and methods of the disclosure each have several innovative aspects directed towards online digital gift presentation and delivery. These systems and methods may be implemented by way of a gift presentation and delivery system, which is configured to allow a gift sender to send, to a gift recipient, a digital gift in a digital gift container that includes a gift presentation generated by the gift presentation and delivery system. Digital gifts can include both electronic gifts, such as e-books, music, video, applications as well as virtual gifts, services or digital notifications of the transfer of physical gifts. The gift presentation can be generated with input received from the gift sender. The gift presentation can include data content, such as images, videos, music, messages, applications, games and puzzles, amongst others. The data content can be personalized or customized to cater towards the particular gift recipient. The gift presentation is configured to be presented on a computing device associated with the gift recipient. In some implementations, the gift presentation may be interactive such that the gift recipient can perform actions within the gift presentation. For example, the gift recipient may be able to play a game included in the gift presentation, move images around a display of the computing device, amongst others. Presentation may mimic the appearance of a gift concealed beneath physical or digital objects, or may display the gift on other ways. In some implementations, the data content, functionality and display included within the gift presentation is customized for the gift recipient. In this way, the gift presentation, when presented to the gift recipient, may evoke emotions that are otherwise not evoked when receiving digital gifts electronically in traditional gift delivery methods.

The digital gift and the gift presentation can be presented to the gift recipient within a digital gift container. The digital gift container may be presented to the gift recipient online. In some implementations, the gift container may include one or more conditions, which when fulfilled, cause the gift to become accessible to the gift recipient. The conditions may be pre-defined by the gift sender. Further, the conditions may be event-based or activity-based conditions, or any combination of event-based and activity-based conditions, amongst others. Event-based conditions are conditions that are satisfied automatically upon the occurrence of a particular event. For example, the event may be a temporal event, such as the current date or time reaching a particular date or time, or a location-based event, such as the gift recipient being present at a particular location. Generally, an event-based condition can be based on any detectable state. In some implementations, an event-based condition can be based on any states detectable by third party application programming interfaces. For example, weather conditions, the direction the user is facing, the proximity of the user from a particular place, person or object, a heart rate of the user, or any other state that can be detectable by one or more application programming interfaces. Activity-based conditions are conditions that are satisfied upon a particular action taking place. For example, an action may include an interaction with the gift presentation, such as playing a game or moving a picture to or away from a particular location on the display.

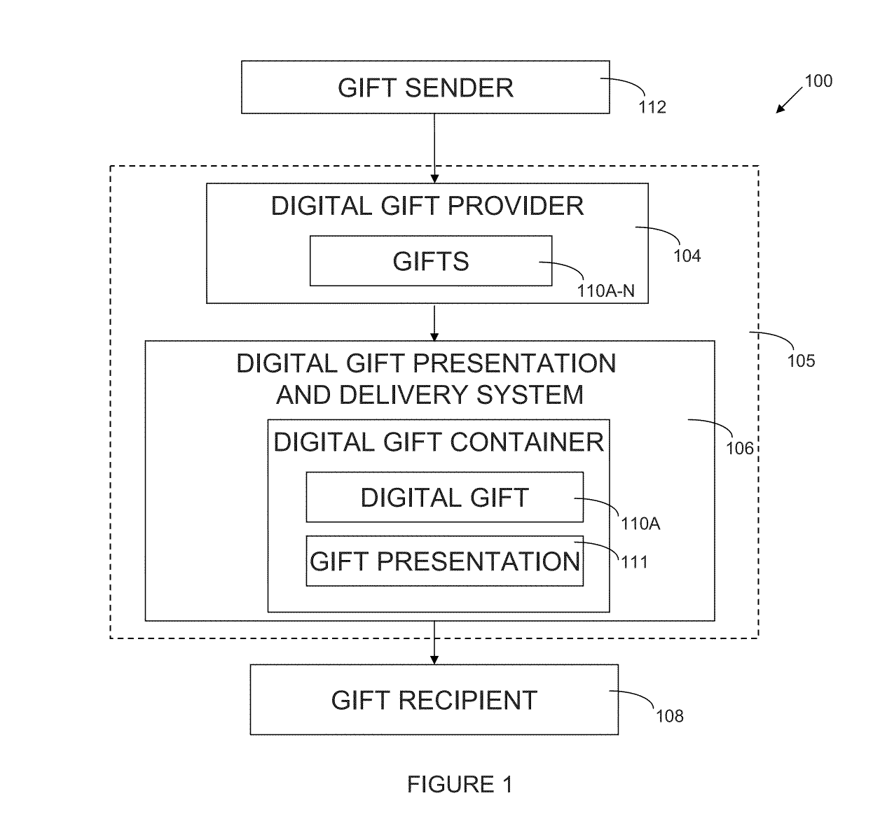

Referring now to the figures, FIG. 1 illustrates an embodiment of an environment for digital gift presentation and delivery. The environment 100 can include a gift sender 102, a gift provider 104, a gift presentation and delivery system 106 and a gift recipient 108. In particular, the gift sender 102 can select a gift 110 from the gift provider 104, have the gift presentation and delivery system 106 generate a gift presentation 111 for the gift 110, which are then delivered to the gift recipient 108 in a gift container 112. In some implementations, the gift provider 104 and the gift presentation and delivery system 106 may communicate with one another within a network 105, such as the Internet. In some implementations, the gift provider 104 and the gift presentation and delivery system 106 may be integrated such that the gift sender 102 or the gift recipient 104 may be able to interact with both the gift provider 104 and the gift presentation and delivery system 106 in a single instance.

A gift 110 may comprise any type and form of product, service, money, offer, value or consideration. A gift may be given by one person to another person or entity. A gift may be given by an entity to another person or entity. A gift may be given by a person or entity to itself. The gift may include any type and form of digital gifts or gifts that may be given or delivered electronically or an indication of a physical gift. A digital gift may include digital gifts, virtual gifts, or services, digital notifications of the transfer of physical gifts. A digital gift may include a gift that is given, delivered or presented digitally, such as online or via email. As described above, digital gifts can include electronic books, commonly referred to as e-books, music, songs, movies, TV shows, applications, games, each of which can be manifested as data content or executable instructions. In addition, digital gifts can include digital coupons or incentives, digital gift cards, subscriptions to online services or physical goods or digital gift certificates that can be acquired online. These digital coupons or incentives may be redeemed either online or offline. Examples of digital services are services that can be redeemed online, such as cloud storage or virus protection services, amongst others. Examples of digital gifts that can be redeemed offline include gift certificates or coupons for tennis lessons or yoga classes or a manicure that are redeemed offline. Other example of digital gifts can include alternative gifts, which includes the donation of money or other valuable item on behalf of the gift recipient to a third party, including but not limited to a charitable organization. Digital gifts can include virtual gifts, such as an item in a virtual world. Such items may have a social capital value, esthetic value or functional value in a virtual world.

A gift presentation may comprise any type and form of programming constructs for presenting a gift. The gift presentation may comprise any type and form of data structures, objects, executable instructions and data for presenting the gift. In particular, the gift presentation may include objects of data content and computer-executable instructions, which when executed by a computer, presents, to a gift recipient, a gift presentation that includes an ordered media presentation of the objects of data content.

The gift provider 104 may be any type and form of retailer, store, entity or commerce source from which a product and/or service may be obtained, acquired, purchased and/or delivered. In some embodiments, the gift provider is an entity from which a product and/or service is electronically obtained, acquired, purchased and/or delivered. In some embodiments, the gift provider may be an e-commerce platform, such as an online retailer, an online store front, a shopping cart, or any other website or application through which good and/or services may be acquired or purchases, such as digital gifts 110 may be selected for presenting as a gift. The gift provider may operate on one or more computing devices, such as servers, and have systems and interfaces for electronically obtained, acquired, purchased and/or delivered, such as via web-site store front, shopping cards and payment systems.

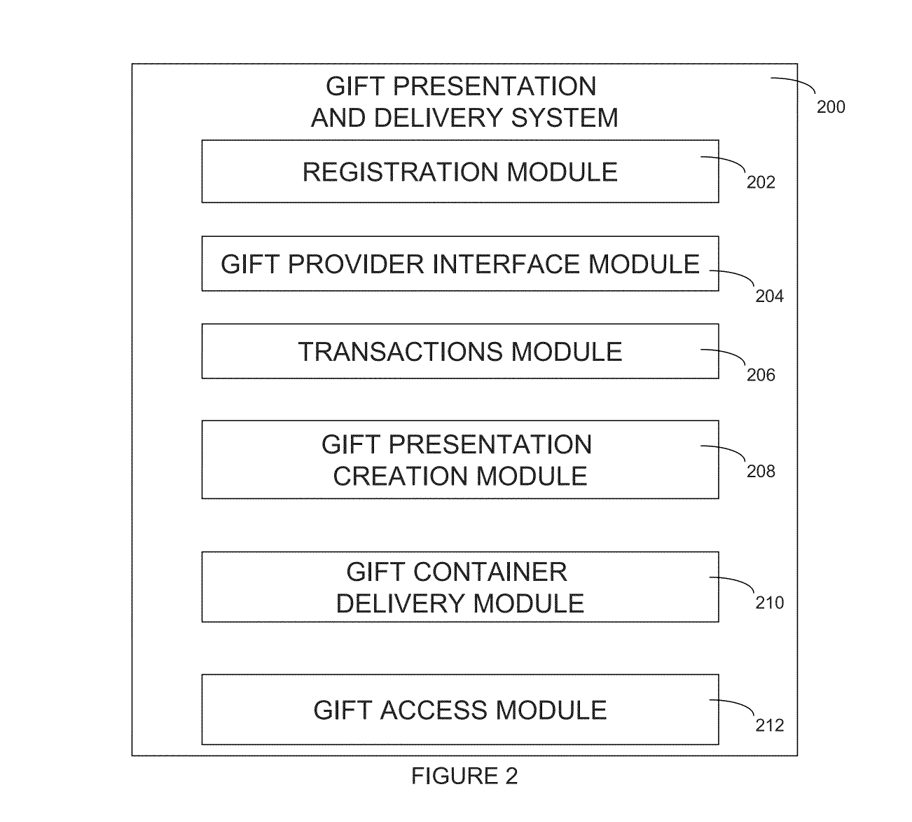

The gift presentation and delivery system 106 is designed and constructed or otherwise configured to provide the systems and methods described herein, such as generate, provide and/or deliver the gift presentation 111 for the gift 110 via a gift container 112. The system 106 may comprise an application, program, library, scripts services, processes, tasks or any type and form of executable instructions executing on one or more computing devices. The system may be designed and constructed to provide interfaces to or otherwise communicate, integrate with or interface to one or more gift providers. The system may be designed and constructed to provide interfaces to or otherwise communicate, integrate with or interface to one or more gift senders and one or more gift recipients. The logic, functions and/or operations of the gift presentation and delivery system 106 is designed and constructed or otherwise configured to deliver the gift presentation 111 and the gift 110 in the digital gift container 112 to one or more gift recipients 108. Similar to a gift wrap in the offline world, the gift presentation 111 can in some implementations, be understood to be a digital gift wrap for the digital gift 110. In some implementations, the gift presentation and delivery system 106 can receive, from at least one of the gift provider or the gift sender, gift related information as well as information related to the gift sender 102 and the gift recipient 108. Additional details related to the gift presentation and delivery system 106 are provided below with respect to FIG. 2.

The gift sender 102, or the senders in the case where multiple people collaborate on presenting a gift, may be a user that wants to or otherwise sends a gift to another user or entity, such as using the electronic of digital gift wrapping service of the system 106. The gift sender 102 may be the same user that purchased, acquired or obtained the gift. The gift sender 102 may be a user different from the user that purchased, acquired or obtained the gift. A gift sender 102 may communicate with the gift provider 104 and the gift presentation and delivery system 106 over the network 105. The gift sender 102 may communicate using any type and form computing device, including but not limited to, a desktop, a laptop, a tablet, a smartphone, or any other computing device that enables the gift sender 102 to communicate with the gift provider 104 or the gift presentation and delivery system 106.

In some embodiments, portions of the system 106 may be implemented and/or executed on the computing device of the gift sender 102 to interact with the gift presentation and delivery system 106 to create a gift presentation for the gift 110 to be delivered to the gift recipient 108. In some embodiments, an agent, such as a script, application or browser based executable instructions may execute on the computing device of the gift sender 102 for the gift sender to select, design or configure the gift presentation 111 for the gift 110 and/or to identify the gift recipient 108 and/or any information for the delivery of the gift to the gift recipient 108.

Similarly, the gift recipient 108 may be any user that is intended to receive a gift 110, targeted to receive a gift or otherwise receives a gift, such as a gift delivered via the system 106 on behalf of a gift sender 102. The gift recipient 108 may be another user of the system 106. The gift recipient 108 may be a user able to electronically receive a communication via an electronic device, such as via texting, email, online communities, social media, etc. The gift recipient may be a user that can communicate with the gift provider 104 and the gift presentation and delivery system 106 over the network 105. The gift recipient 108 may communicate using a computing device, including but not limited to, a desktop, a laptop, a tablet, a smartphone, or any other computing device that enables the gift recipient to communicate with the gift provider 104 or the gift presentation and delivery system 106. In some embodiments, the device of the gift recipient 108 may be configured to receive, from the gift presentation and delivery system 106, the gift container 112 that includes the gift 110 and the gift presentation 111 created by the gift presentation and delivery system 106. In some embodiments, portions of the system 106, such as an agent, script, application or executable instructions may execute on the device of the gift reception to receive the gift via the gift container and/or to effect and cause the delivery of the gift presentation.

Referring now also to FIG. 2, an embodiment of the gift presentation and delivery system 106 is shown. The gift presentation and delivery system 106 includes a registration module 202, a gift provider interface module 204, a transactions module 206, a gift presentation creation module 208, a gift container delivery module 210 and a gift access module 212.

The registration module 202 is configured to manage registration of users with the system, such as gift providers, gift sender and gift recipients. In some implementations, the registration module 202 manages the registration of one or more gift providers 104 with which the gift presentation and delivery system 106 interacts. In addition, the registration module 202 manages the registration of one or more gift senders that create gift presentations using the gift presentation and delivery system 106 and one or more gift recipients 108 to which the gift presentation and delivery system 106 delivers the digital gifts sent from the gift sender 104. In some implementations, the gift presentation and delivery system 106 maintains one or more databases in which information related to gift senders 102, gift providers 104 and gift recipients 108 are stored. In some implementations, the registration module 202 stores identification information of the gift sender 102 as well as information provided by the gift sender 102, including the name and address information of the gift recipient 108, the digital gift 110 being presented and one more pieces of data content, such as pictures, videos, audio files, as well as text, that are provided by the gift sender 102 for incorporation in the gift presentation 111. The address information of the gift recipient can be an email address, social media profile, or another form of unique identifier. In some implementations, the registration module 202 stores identification information of the gift provider 104, including instructions for communicating with the gift provider 104. In some implementations, the registration module 202 stores cryptographic data used to establish a secure connection for transferring information about the sender, recipient, and gift, such as a unique transaction code that may be used for redeeming the gift. In some implementations, the registration module 202 stores identification information of the gift recipient 108 including information related to the received gift 110, including but not limited to the gift provider 104 that provided the gift 110 and the gift sender 102 that sent the gift 110 to the gift recipient 108.

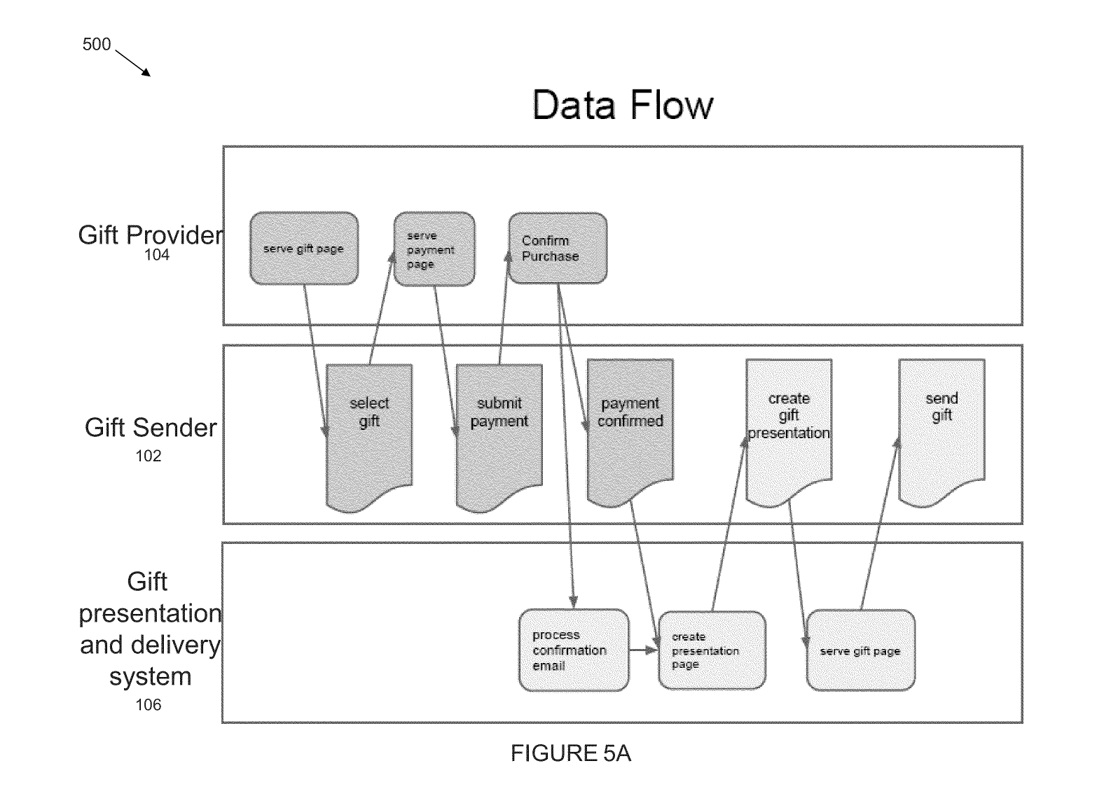

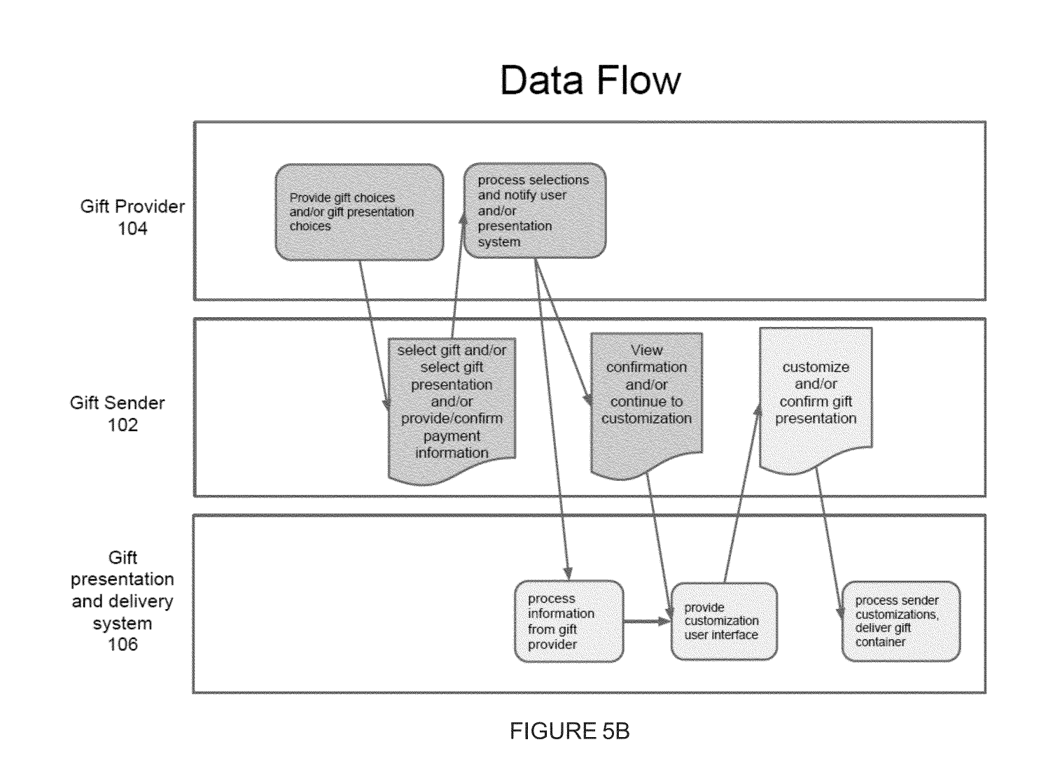

The gift provider interface module 204 may comprise any type and form of interface for integrating with, communicating and/or interfacing to applications, systems and or devices of one or more gift providers. The gift provider interface may include an application programming interface (API) for accessing the services and functionality of the system 106. The gift provider interface may include an agent, script, application or other executable instructions to execute on the device(s) of gift provider to implement or provide access to the system 106. The gift provider interface may be configured to facilitate the communications between the gift presentation and delivery system 106 and the gift provider 104. In some embodiments, the gift provider may call, execute or access the interface for the gift presentation and delivery system 106. In this way, the gift sender 102 may be able to interact with the gift presentation and delivery system 106 via the gift provider 104. In such embodiments, the gift presentation and delivery system 106 may interact with the gift provider 104 such that a gift sender 102 may select a gift, create a gift presentation for the selected gift, and create a gift container 112 that includes the gift 110 and the gift presentation 111 delivered to or accessed by a gift recipient 108. In some embodiments, the gift presentation and delivery system 106 is configured to be integrated with the gift provider 104. In such embodiments, the gift sender 102 may select a gift, create a gift presentation for the selected gift, and have the gift presentation delivered to the gift recipient 108 while interacting via a user interface provided by a website or application corresponding to the gift provider 104. In some implementations, the gift provider is configured to provide the gift presentation and delivery system 106 information associated with the selected gift and the gift sender 102, including but not limited to the name and identifying information of the gift sender. Additional details regarding the interaction between the gift provider 104 and the gift presentation and delivery system 106 are provided below with respect to FIGS. 5A and 5B.

The transaction module 206 is configured to execute, facilitate, track or otherwise manage transactions associated with the creation and delivery of the gift container 112 and its contents. In some implementations, the gift presentation and delivery system 106 is configured to receive payment information from the gift sender 102 directly or via the gift provider 104. In some cases, the gift presentation and delivery system may be configured to communicate with a third party electronic payment processor (such as PayPal) to execute payment. In some implementations, the gift presentation and delivery system 106 is configured to receive payment information from the gift provider 104. The transaction module 206 may be configured to execute such payments. In addition, the transaction module 206 may be configured to manage transactions between one or more gift senders 102 and gift providers 104 and the gift presentation and delivery system 106, including storing the transactions in one or more databases accessible by the gift presentation and delivery system 106.

The gift presentation creation module 208 is configured to create gift presentations. The gift presentation creation module 208 may be any type and form of application or tool that provides a user interface or designer for a user to select, create or configure a gift presentation. The gift presentation creation module 208 may be configured to a access one or more databases that store template gift presentations, or store one or more components, such as animations, graphics, data content, animation sequences, etc. that may be included in a gift presentation. The gift presentation creation module 208 can be further configured to provide a graphical user interface for a user to select from templates of gift delivery. The gift presentation creation module 208 can be further configured to provide a graphical user interface for users to design a gift presentation. The gift presentation creation module 208 may include an interface for creating, generating, incorporating integrations, scripts, programs, applications that may be used to create a gift presentation.

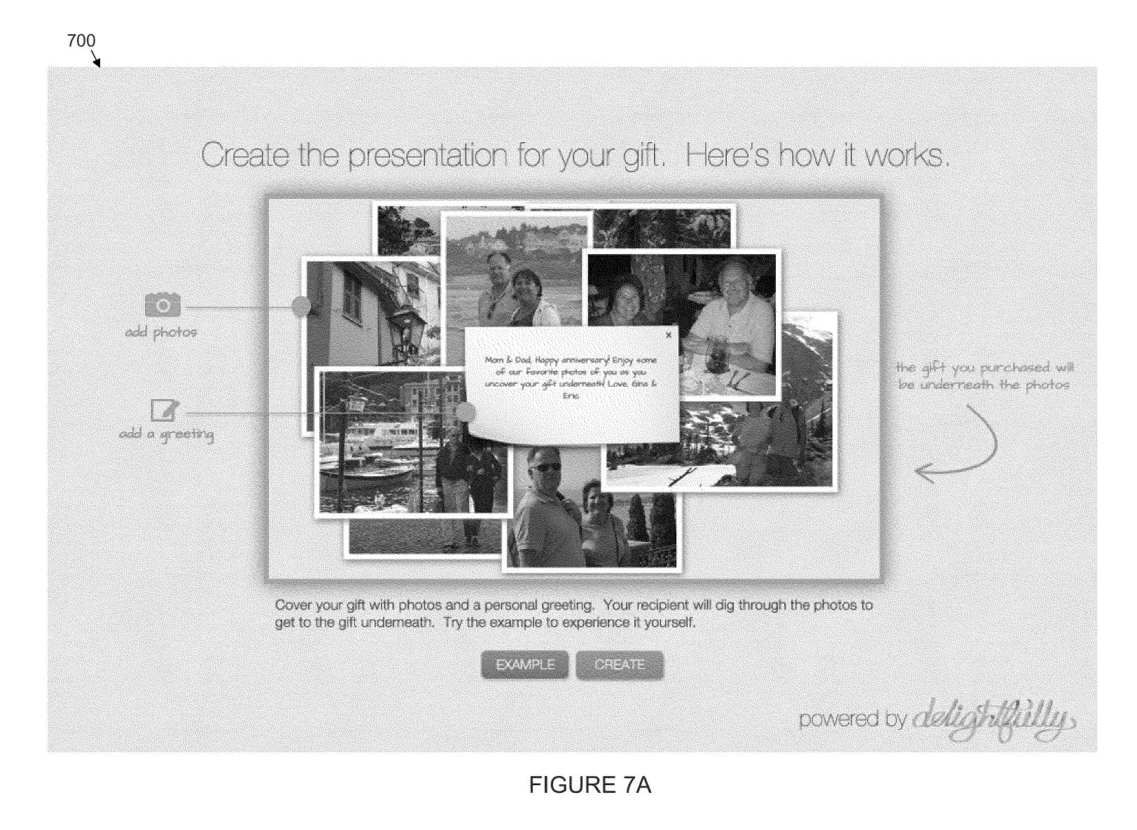

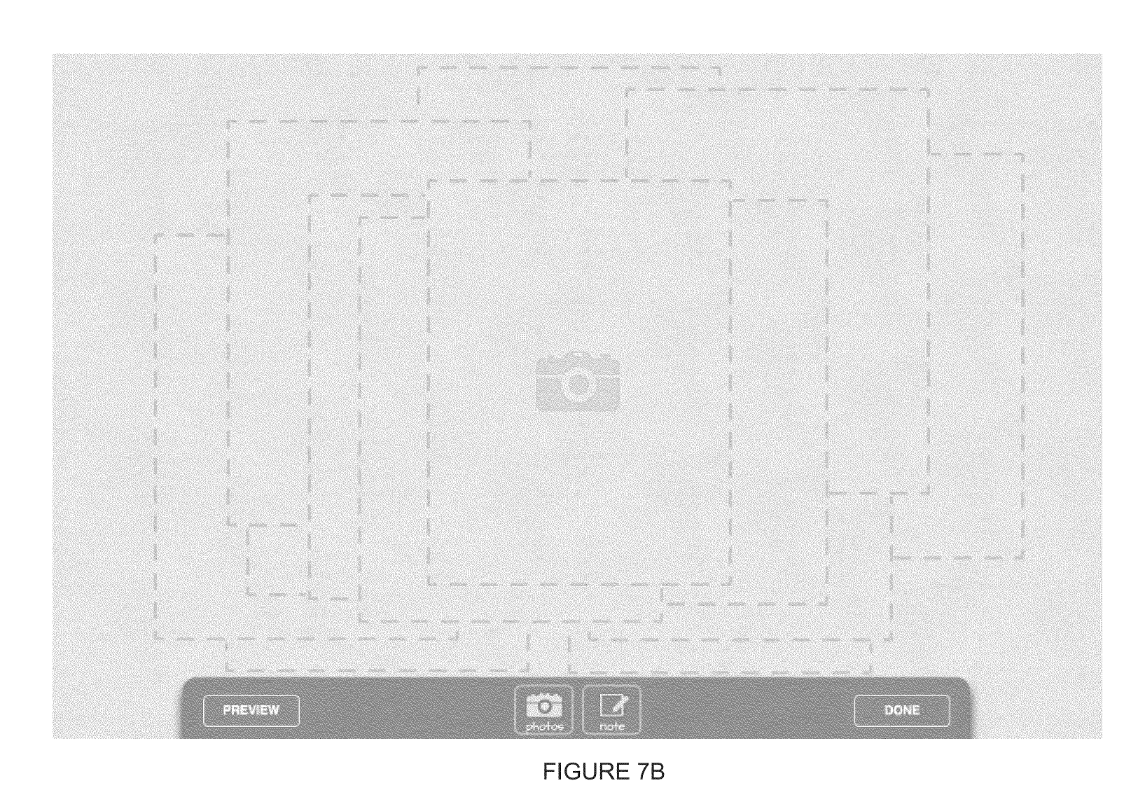

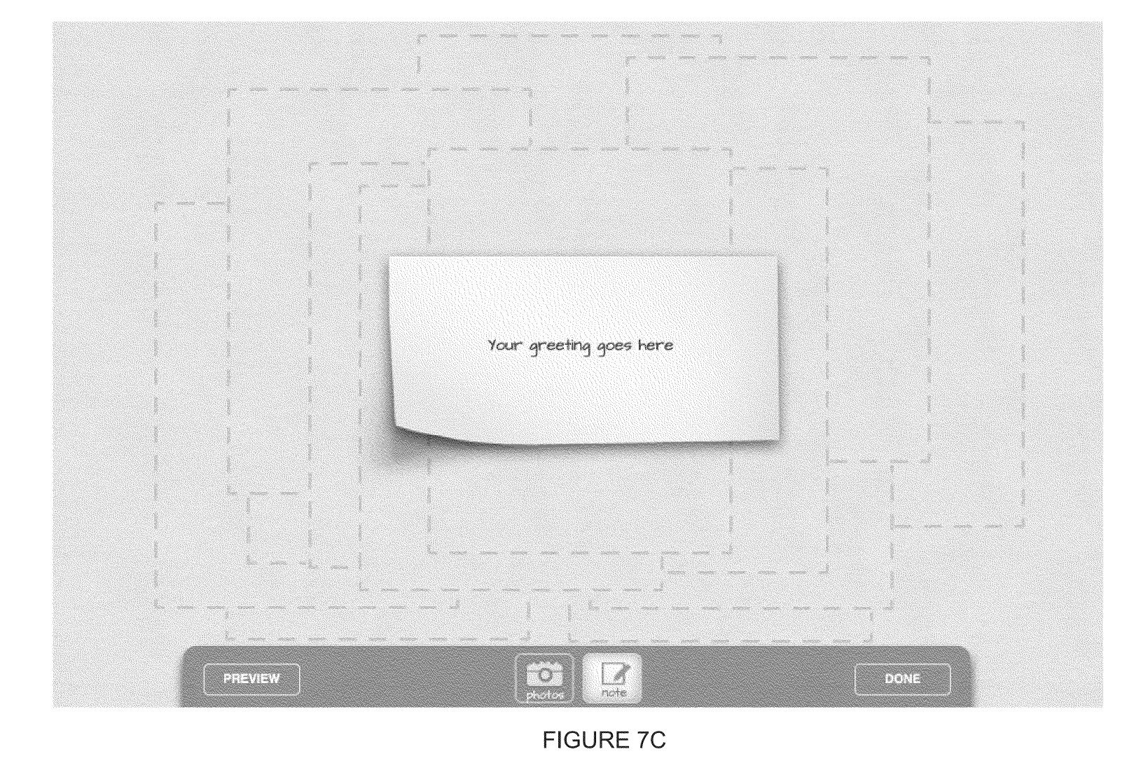

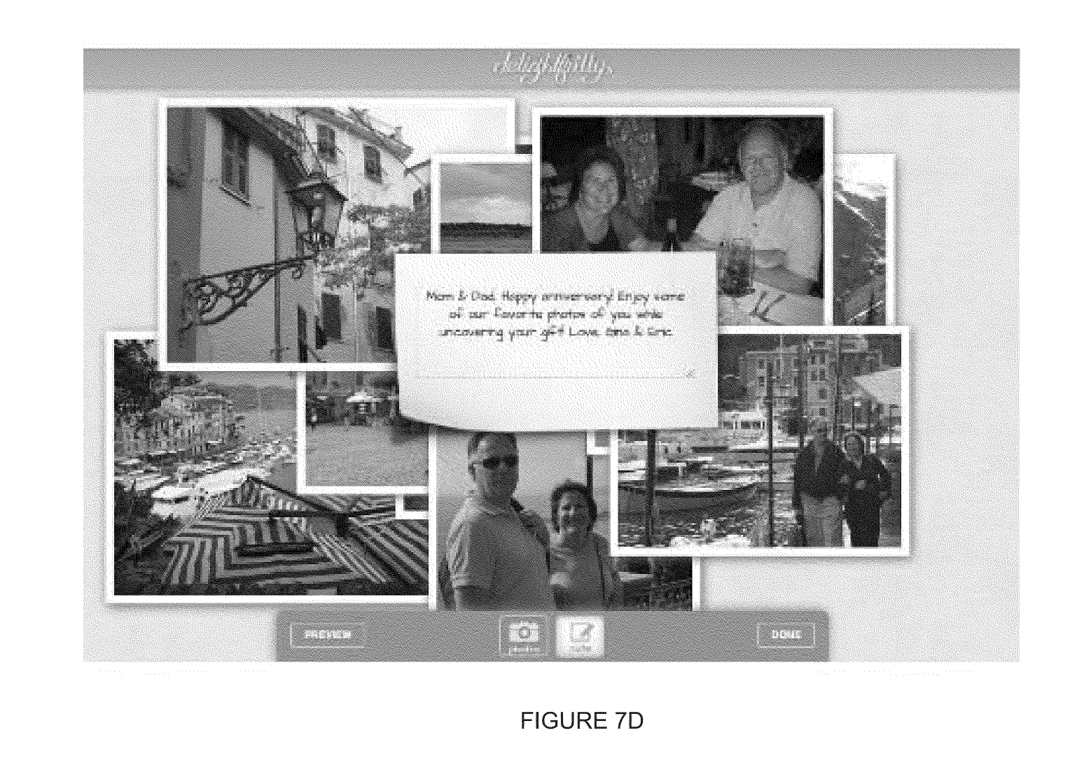

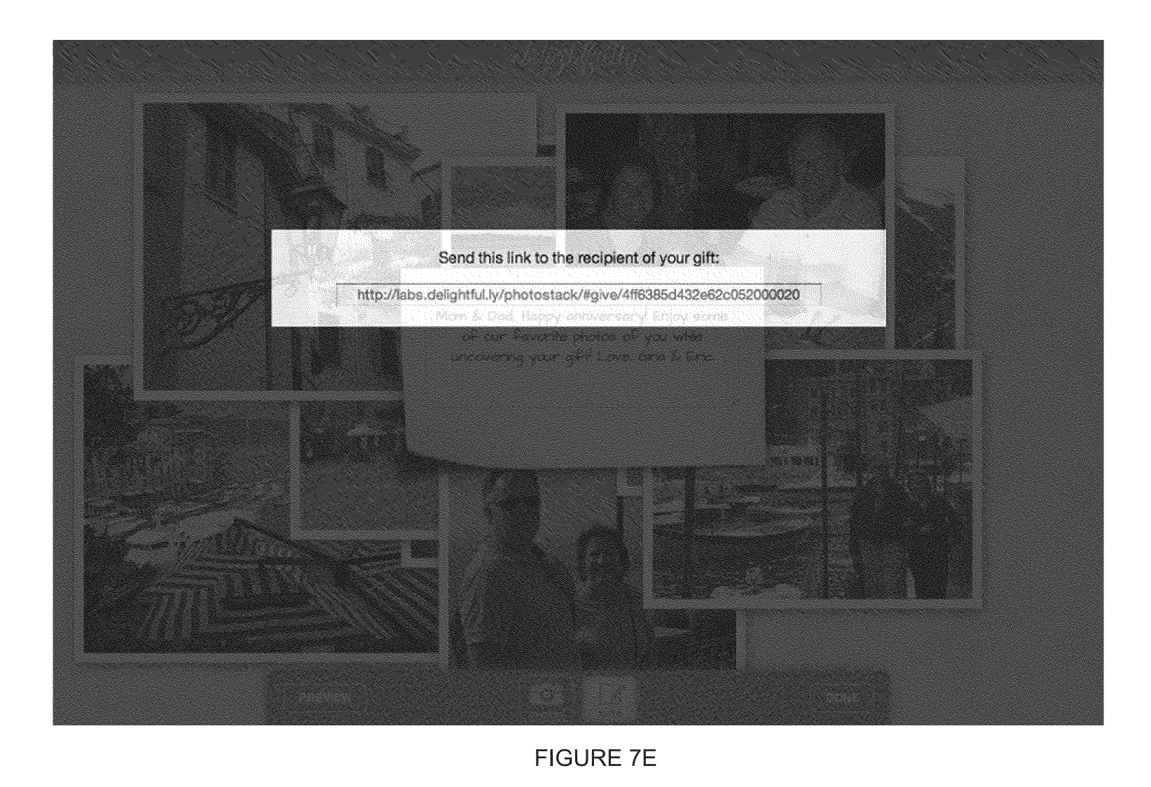

The gift presentation creation module 208 is configured to present a user interface through which a gift sender, such as the gift sender 102, can provide input for the creation of a customized gift presentation. The gift presentation creation module 208 can allow the gift sender 102 to create a gift presentation, such as the gift presentation 111, which reveals a gift, such as the digital gift 110, upon satisfying one or more pre-defined conditions. In some implementations, the pre-defined conditions may be provided by the user providing input for the creation of the gift presentation. Examples of conditions include physical actions, time conditions, geographic conditions, or any other conditions predefined by the user. In some implementations, the conditions may be performed automatically. In some implementations, the conditions may be performed by the gift recipient 108 or the gift sender 102 or both the gift recipient 108 and the gift sender 102. In some implementations, the gift presentation creation module 208 is configured to receive content that may be incorporated into the gift presentation. Examples include but are not limited to pictures, videos, images, graphics, icons, audio files, songs, voice recordings, text, applications, games, or other interactive applications. In some implementations, the content may be received from the gift sender 102 or the gift provider 104. In some implementations, the content may be received from a third party, such as an application marketplace or a database that stores content, including applications, video content or other content that can be utilized to create the gift presentation 111. In some implementations, once a gift presentation 111 is created, the gift presentation 111 is stored as a gift presentation object in a database. An example of the user interface is shown in FIGS. 7A-7D. Additional details regarding the user interface are provided below during a discussion of FIGS. 7A-7D.

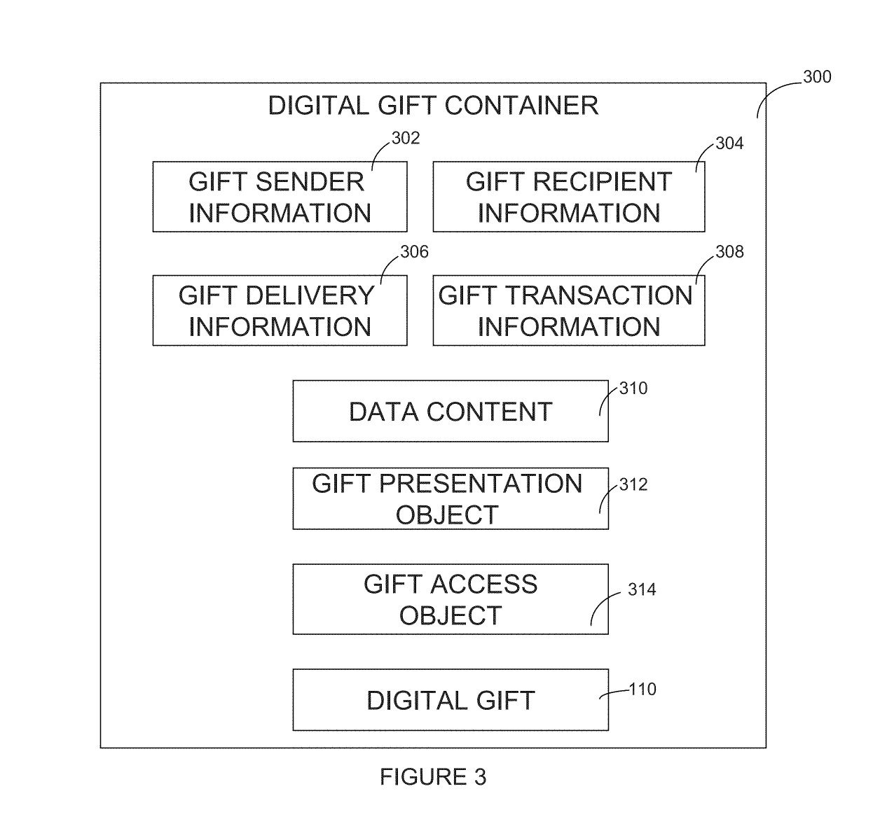

The gift container delivery module 210 is configured to generate a gift container, such as the gift container 112, which includes the digital gift 110 and the associated gift presentation 111. A gift container may comprise any type and form of programming constructs for storing, holding, transmitting and/or effecting the delivery of a gift. The gift container may comprise any type and form of data structures, objects, executable instructions and data for identifying, holding or carrying the gift and/or the gift presentation and/or any associated information. The gift container 112 may comprise a data structure or object for transmitting or delivering the gift 110 or an indication of the gift and/or gift presentation 111 to the gift recipient 108. The gift container 112 may be an application layer object that is transmitted over transport layer communications, such as an object communicated via HTTP payload over TCP/IP communications. Additional details regarding the gift container 112 are provided below with respect to FIG. 3. Further, the gift container delivery module 210 is configured to deliver the gift container 112 to the recipient 108. In some implementations, the gift container delivery module 210 may also send the gift container 111 to the gift sender 102. In some implementations, the gift container delivery module 210 may send a notification to the gift sender 102 that the gift container 112 has been delivered. The gift container delivery module 210 can send the gift container 112 to the gift recipient as an email, text message, instant message, push notification, or via other communication means. In some implementations, the gift container 112 may be stored on a server accessible by the gift recipient 108. In such implementations, the gift recipient 108 may access the gift container 112 by communicating with the server via a web browser, a web-based application or a native application accessible via a computing device associated with the gift recipient 108. In some implementations, the gift container delivery module 210 sends a link to the gift container 112 to the gift recipient 108, through which the gift recipient 108 can access the gift presentation 111. In some implementations, the gift container delivery module 210 sends a notification to the gift recipient 108 indicating that the gift recipient 108 has received a gift. In such implementations, the notification can be in the form of an email, a text message, an instant message, a notification from an application, a web browser notification, amongst others.

The gift access module 212 is configured to provide the gift recipient 108 access to the digital gift 110. As described above, the gift 110 and the gift presentation 111 may be contained in the gift container 112. In some implementations, the gift access module 212 is configured to present the gift presentation 111 to the gift recipient. The gift presentation 111 may include certain pre-defined conditions, which when satisfied, cause the gift to be made accessible by the gift recipient 108 or cause the identity of the gift to be revealed to the gift recipient 108. Additional details regarding various types of conditions are provided below. In some implementations, the gift access module 212 is configured to monitor events or actions related to the pre-defined conditions and determine if any events or actions that satisfy those conditions have been performed. In some implementations, the gift access module 212 may be configured to identify actions performed and determine if those actions satisfy one or more of the pre-defined conditions. Further, upon determining that one or more of the pre-defined conditions have been satisfied, the gift access module 212 may be configured to provide the gift recipient access to the gift.

The conditions may be pre-defined by the gift sender. Further, the conditions may be event-based conditions or activity-based conditions, amongst others. The conditions may also be a combination of event-based and activity-based.

As described above, event-based conditions are conditions that are satisfied automatically upon the occurrence of a particular event. For example, the event may be a temporal event, such as the current date or time reaching a particular date or time, or a location-based event, such as the gift recipient being present at a particular location. Other examples of event-based conditions include time, date, duration of time, location, movement patterns, elevation, direction the gift recipient faces, weather conditions, any environmental states detectable by third party application programming interfaces, any other environmental states detectable by device sensors, such as light, or any combination thereof.

Activity-based conditions are conditions that are satisfied upon a particular action taking place. For example, an action may include an interaction with the gift presentation and delivery system. In some implementations, the actions may be performed by the gift recipient 108 or the gift sender 102. In some implementations, the actions may include moving a picture that is presented on a user interface from a first location to another location. In some implementations, the actions may include playing a game, or more specifically, reaching a particular score in a game. In some implementations, the actions may be performed outside the domain of the gift presentation. In other words, the action may include visiting a particular website or taking a picture from a camera. Another type of activity-based condition can be based on actions performed by performed by one or more gift senders (in the case of a group gift) and/or one or more recipients (in a case of a gift sent to a group). For example, an activity-based condition can include causing the gift sender to log on to the gift presentation and delivery system 106 at the time the gift is accessed by the gift recipient. In some implementations, the condition can be the initiation of a video conference between the gift sender and the gift recipient. In such a condition, the gift access module 212 may be configured to detect that a video conference between the gift sender and the gift recipient is taking place. In some implementations, the video conference may be initiated using a third party application or plug-in that is associated with the gift presentation and delivery system 106.

In some implementations, the gift presentation and delivery system 106 may include one or more of the modules 202-212 and may include one or more additional modules configured to perform additional functions. In some implementations, one or more modules 202-212 may be combined to perform the functionality of each of the modules that are combined.

FIG. 3 shows a block diagram of an embodiment of gift container. The gift container 300 includes information that may be useful to deliver the gift to the gift recipient. In some implementations, the gift container 300 is an object that includes gift sender information 302, gift recipient information 304, gift delivery information 306, gift transaction information 308, data content 310, the gift presentation object 312, the gift access object 314 and the digital gift 110. The gift container 300 may be stored as an object in a database.

The gift sender information 302 may include information about the gift sender. Examples of information include the gift sender's name, contact information, such as an email address, computing device identifying information, such as an IP address of a computing device associated with the gift sender or other identifying information associated with a mobile device or tablet or any other computing device. The gift recipient information 302 may include information about the gift recipient. Examples of information include the gift recipient's name and contact information, such as an email address, amongst other types of information. The gift delivery information 306 includes information on the type of gift, the type of gift presentation, the type of delivery mechanism, as well as other information about when and how the gift presentation is to be delivered. The gift presentation may be delivered via email, text message, instant message or via a notification indicating that a gift presentation is waiting, amongst others. The gift transaction information 308 may include information about a transaction related to the gift or the gift presentation. In some implementations, the information can include the name of the gift provider, a digital gift receipt of the gift, a gift identification number that may be unique to the gift provider, an image of a physical gift, as well as any transaction information related to the gift presentation.

The gift container 300 can also include data content 310, which includes visual content, such as pictures, images, graphics, videos, text, amongst others and audio content, such as music, voice recordings, sounds, and other audio files. In some implementations, the data content 310 may also include software applications, such as games, puzzles, or any other APIs that may allow the gift presentation to present or utilize the functionality of an external third party application.

The gift container 300 can also include a gift presentation object 312 that contains aspects of the gift presentation generated by the gift presentation creation module 208 described above with respect to FIG. 2. The gift presentation object 312 includes software that renders the gift presentation to the gift recipient. The gift presentation object includes computer-executable instructions that correspond to the arrangement of the data content as well as various functionality associated with the data content. Further, the gift presentation object includes computer-executable instructions that provide a user interface with which the user, such as the gift recipient, can interact with the gift presentation.

Gift presentation 111 comprises any combination of data, executable instructions and display that presents a look and feel and/or behavior that provides an experience or interaction with a user such as a gift recipient. The experience and/or interaction may be equated to or may deliver or effect a gift unwrapping experience for the gift recipient. The data of the gift presentation may identify the gift recipient, the gift sender, the gift, visuals, including videos, images, pictures, graphics, icons, words or messages to be displayed to the gift recipient, and audio to be played to the gift recipient.

Other types of data can include computer-executable instructions related to the presentation of the gift presentation to the gift recipient. The executable instructions of the gift presentation may include an application, script, program, or other executable instructions to provide, deliver or produce the gift presentation. The gift presentation can be a dynamic presentation with one or more media content objects, such as pictures, videos, graphics, animations, etc. being displayed in a display. The media content objects may dynamically change shapes, colors, positions, states, amongst others. The presentation may also include audio media content that can also dynamically change volume, tone, pitch, tempo and the like. The gift presentation includes one or more actions or behaviors associated with the content of the gift presentation. As examples, the gift presentation can include an image of balloons moving across a display, candles being lit on a cake image, pictures moving around the screen, amongst others. In one example, the gift presentation can include a series of photographs displayed sequentially relaying a story. As such, the gift presentation can include data, computer-executable instructions or other logic that controls the timing and presentation of one or more actions or behaviors of the gift presentation.

In some embodiments, the gift presentation may be interactive such that the gift presentation presents a display displaying one or more data content objects that can dynamically change based on responses received from the user. For example, a user may be able to move a picture by sliding the picture across the display screen, a user may be able to play a game via the display, or may be able to interact with images and other display objects by interacting with the gift presentation. It should be appreciated that the interactions may be via a touch screen of the computing device or via an input device, such as a keyboard, mouse, stylus, or other input device. In some implementations, the interactions may be speech-based interactions.

The gift presentation may include any type and form of display aspects, such as visual effects to be displayed, including video, images, graphics, colors, shapes, text, and other visual effects that can be manifested on a display. For example, the gift presentation can display images, such as photographs that change from color to black and white mode; animations, such as fireworks, candles being lit and blown; graphics, such as text changing fonts, sizes, and colors. The system may provide multiple predetermined types of gift presentations. These gift presentations may be stored in one or more databases as an agent, script, application or executable instructions that can be executed to be presented as a gift presentation to a gift recipient. The gift presentations may correspond to a desired or particular experience. For example, the gift presentation may share a travelling experience with the gift recipient by sharing photos and a corresponding map, such as displaying photographs overlayed over an image of a map. In another example, the gift presentation may provide the gift recipient a game playing experience. In such an example, the gift presentation may include presenting a game for playing by the gift recipient. Another example of a particular experience may include mimicking the unwrapping of a gift by moving photographs or other images from a portion proximate the center of the display to a portion away from the center of the display. In one example, the gift presentation can include a puzzle that may have to be solved in order to access the gift associated with the gift presentation.

The predetermined gift presentations may be further configured or customized. For example, the presentations can include customized photographs corresponding to the gift recipient or the gift sender, or may include graphics or animations referencing the gift recipient, gift sender or an event or occasion corresponding to the gift recipient, amongst others.

The gift presentation object 312 may be designed and constructed to store in and retrieve from a database the configuration of a desired gift presentation. The gift container may be designed and constructed to access, obtain, and manage the gift presentation object 312. The gift container may be designed and constructed to execute the gift presentation. Further, the gift container may be designed and constructed to deliver the gift to the gift recipient. In some embodiments, the gift container can store information associated with the gift recipient, including the gift recipient's name, email address or other contact information. Further, the gift container can include delivery information associated with the gift, including the type and manner in which the gift recipient is to be notified of the gift and corresponding gift presentation. Other delivery information can include when the gift recipient should be notified and one or more conditions associated with either notifying the gift recipient or accessing the gift presentation or the gift itself. The system 106 can include computer-executable instructions that are configured to determine delivery information associated with the gift container and to execute the delivery based on such delivery information. In some embodiments, the system 106 can include computer-executable instructions to deliver the gift to the gift recipient by creating an email and sending the email to the gift recipient's email address. In some implementations, the system can include executable instructions for delivering the gift container via email, text messaging, instant messaging or via a web-based or native application.

The gift container 300 can include a gift access object 314 that includes computer-executable instructions for providing the gift recipient access to the gift 310 contained within the gift container 300. The gift access object 314 includes information on one or more conditions which have to be satisfied before access to the gift is provided to the gift recipient. In some implementations, the gift access object 314 is configured to determine if actions performed by the gift recipient or the gift sender satisfy one or more of the conditions associated with the gift. In addition, the gift access object 314 can include computer-executable instructions for communicating with third-party applications or other components or modules that may reside on a computing device of the gift recipient or be accessed by the computing device of the gift recipient. For example, the gift access object may include computer-executable instructions to call a third-party video conferencing application or a third-party game based on conditions defined during the generation of the gift presentation.

In some implementations, the gift presentation and delivery system can also be configured to gauge the response of the gift recipient in response to receiving the gift presentation and/or the gift from the gift sender. In some implementations, the gift presentation and delivery system can identify the response of the gift recipient based on one or more actions taken by the gift recipient. For example, the gift recipient may send a thank you note to the gift recipient, may share the gift with others via a social networking account, amongst others. In addition, the gift presentation and delivery system can also identify one or more responses based on how the gift recipient interacts with the gift presentation itself. For example, the gift presentation and delivery system can identify the speed and pattern of clicks, drags, or touches performed by the gift sender. This may be used to calculate a total time of a gift presentation or an average total time of a gift presentation.

In some implementations, the gift presentation and delivery system can recommend gifts and wrapping based on the gift recipient's responses. In some implementations, the gift presentation and delivery system can be configured to identify, monitor and analyze the gift recipient's actions after the gift is revealed to the gift recipient. These actions can be evaluated to identify how quickly the gift recipient redeems, retrieves or avails the gift. In some implementations, the gifts can be a gift certificate or voucher. In some such implementations, the gift presentation and delivery system can identify what the gift recipient bought with the gift to determine the types of gifts the gift recipient likes. This information can be used to recommend gifts to gift senders wanting to provide a gift to the particular gift recipient or other gift recipients that have similar interests. In some implementations, gift presentations or wrappings can also be suggested. In some implementations, the gift presentation and delivery system can provide recommendations on which gift presentations are to be provided to the gift sender.

In some implementations, the gift presentation and delivery system can also receive information from one or more social networking sites. The gift presentation and delivery system can utilize APIs to retrieve information of gift senders and recipients. Examples of information that may be retrieved include names, gender, email addresses, likes or preferences, relationship status, friends, preferences of friends, birthdays and dates of other occasions for which gifts can be given, such as graduations, anniversaries, amongst others.

In some implementations, the gift presentation and delivery system can be configured to allow multiple gift recipients to collaborate with one another to create a gift presentation. In some such implementations, the gift presentation and delivery system can be configured to receive a request from a first gift sender to create a gift presentation. The request can include a request to identify one or more supplemental gift presentation creators. The gift presentation and delivery system can assign rights to the one or more supplemental gift presentation creators that allow the gift presentation creators to also contribute to the design of the gift presentation. In some implementations, the gift sender can limit the rights of the gift presentation creators or provide them with the same rights as the gift sender. In some implementations, the gift sender can create a payment scheme for the gift presentation creators. The payment scheme can be based on splitting the cost of the gift or a voluntary contribution towards the gift. In some implementations, the gift presentation and delivery system can send invitations to each of the gift presentation creators and may also be configured to create user accounts for one or more of the gift presentation creators. In some implementations, the gift presentation and delivery system can also be configured to provide a gift to multiple gift recipients. In some such implementations, the gift presentation and delivery system can be configured to customize the gift presentation based on the gift recipient accessing the gift presentation. In this way, the gift sender can create one gift presentation while allowing the gift presentation and delivery system to customize the gift presentation for each of the gift recipients.

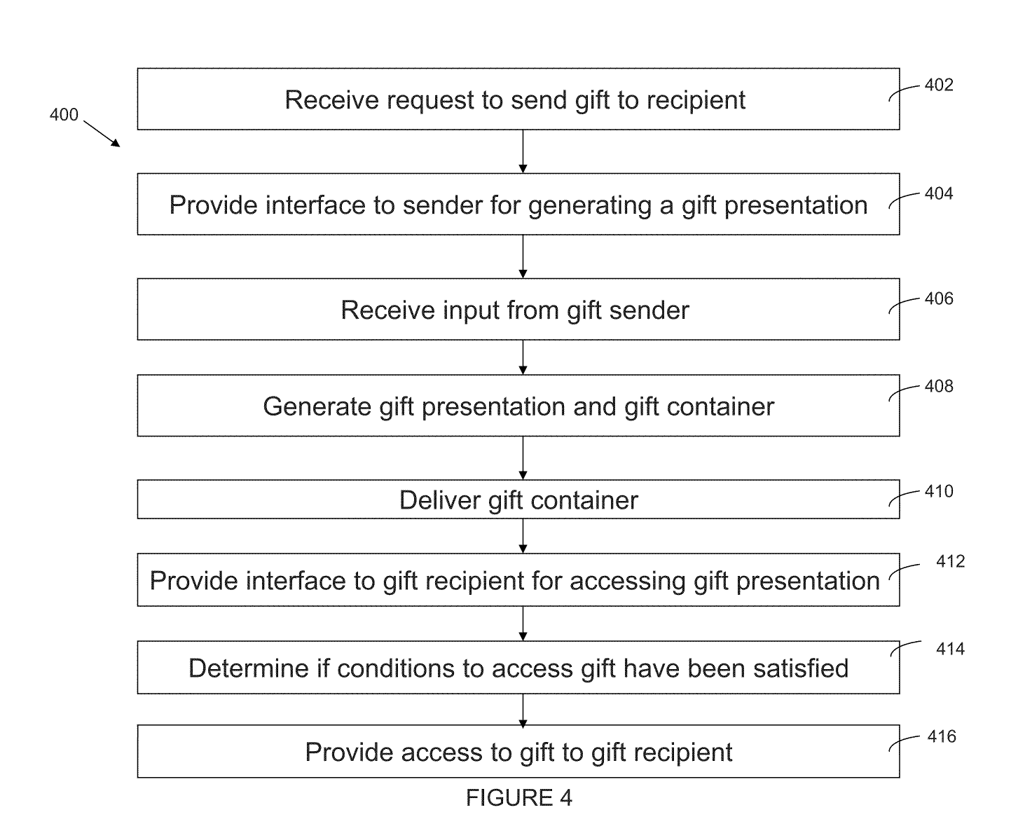

Referring now to FIG. 4, an example flow chart of a process 400 for generating and delivering a gift container including a gift presentation and a gift to a gift recipient is shown. In brief overview of method 400, at step 402, the gift presentation and delivery system receives a request to send a gift to a recipient. At step 404, the gift presentation and delivery system provides a user interface to the gift sender for generating a gift presentation. At step 406, the gift presentation and delivery system receives input from the gift sender via the user interface. At step 408, the gift presentation and delivery system generates a gift presentation and a gift container corresponding to the gift. At step 410, the gift presentation and delivery system delivers the gift container to the gift recipient. At step 412, the gift presentation and delivery system provides a user interface to the gift recipient for accessing the gift presentation. At step 414, the gift presentation and delivery system determines if conditions to access the gift have been satisfied. At step 416 the gift presentation and delivery system 106 provides the gift recipient access to the gift.

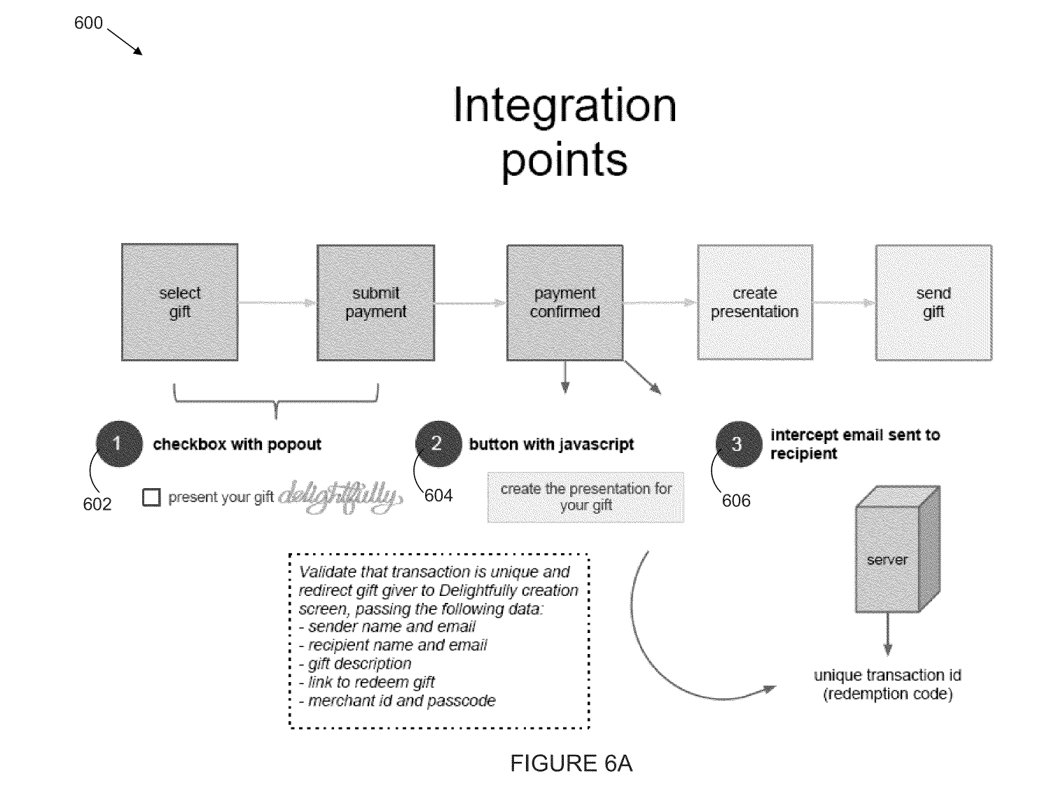

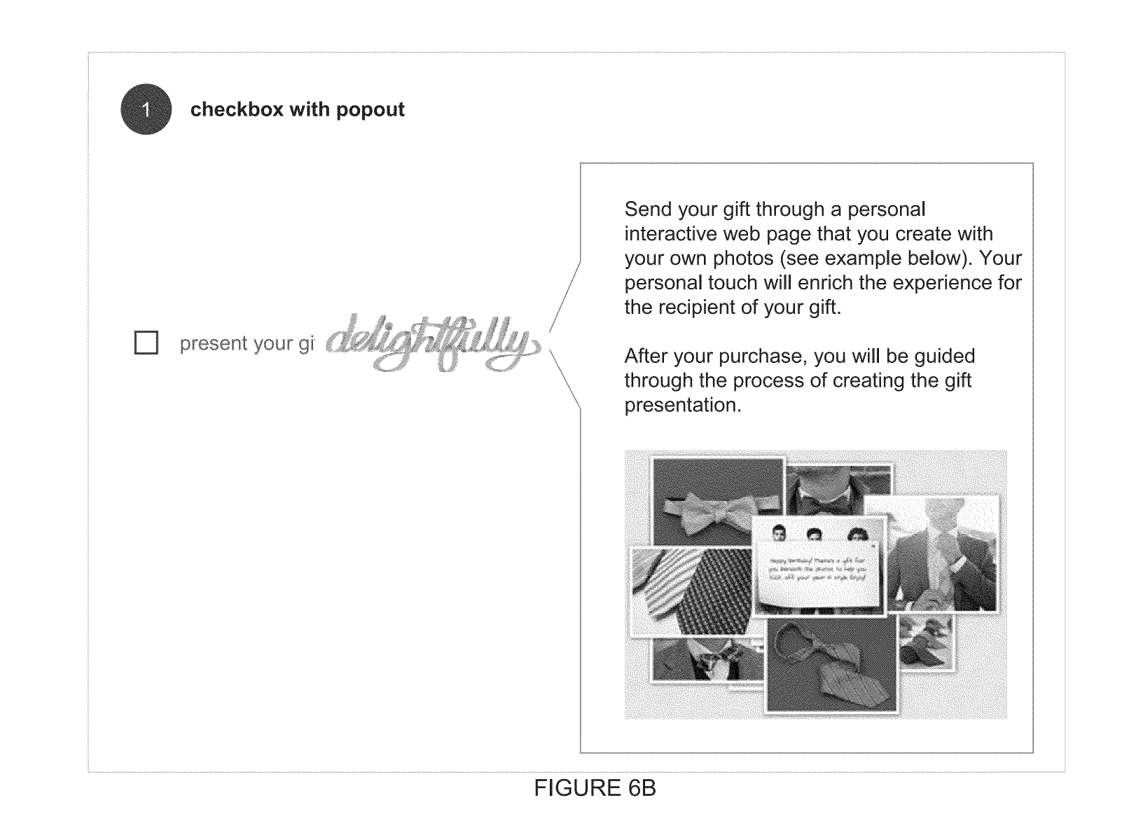

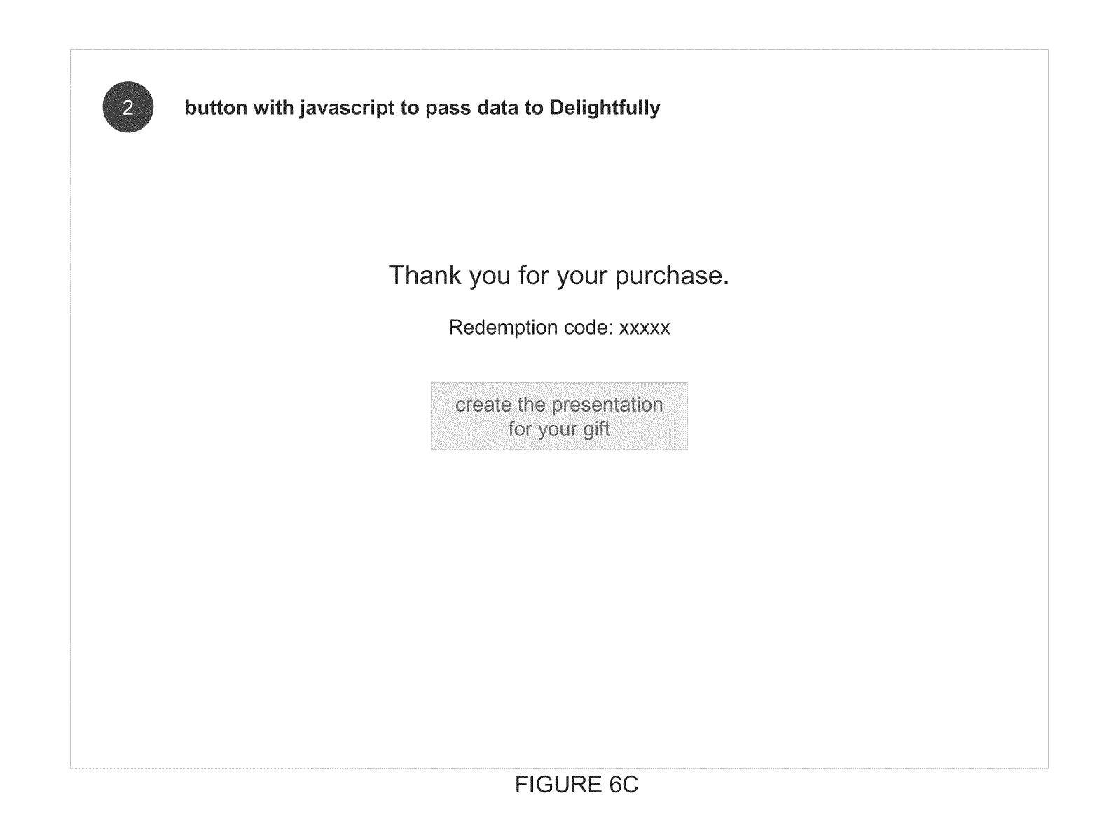

In further detail, at step 402, the gift presentation and delivery system receives a request to send a gift to a recipient. The request may be received directly from a gift sender or in some implementations, from a gift provider. In some implementations, the gift sender may send a request to the gift presentation and delivery system 106 via the gift provider, such as after the gift sender selects a gift from the gift provider. FIG. 6A-6C, described below, provides various integration methods between the gift provider and the gift presentation and delivery system that allow the gift sender to communicate with the gift presentation and delivery system.

At step 404, the gift presentation and delivery system provides a user interface to the gift sender for generating a gift presentation. The user interface may be provided as a pop-up screen or may be provided in another browser window. It may also be presented in the same window or embedded in another user interface, such as a gift provider's website. In some implementations, an applet or application is launched that provides the user interface to the gift sender. An example of the user interface is described below with respect to FIG. 7A-7E.

At step 406, the gift presentation and delivery system receives input from the gift sender via the user interface. In some implementations, the gift sender can provide data content, including pictures, videos, audio files, and the like that may be used to create the gift presentation. Further, the gift sender can provide input on how the data content should be presented and/or how the gift recipient can interact with it, including but not limited to, where the data content should be placed and how and when the data content can be moved or adjusted. In some implementations, the gift sender can provide input regarding event-based conditions and activity-based conditions that have to be satisfied to allow the gift to be accessed.

At step 408, the gift presentation and delivery system generates a gift presentation and a gift container corresponding to the gift. The gift presentation can be generated based on the input provided by the gift sender. In addition, the gift container can also be generated. The gift container 300 can include information that may be useful to deliver the gift to the gift recipient. In some implementations, the gift container can include gift sender information, gift recipient information, gift delivery information, gift transaction information, data content, a gift presentation object, a gift access object and the digital gift.

At step 410, the gift presentation and delivery system delivers the gift container to the gift recipient. The gift presentation and delivery system 106 may deliver the gift container via email, text message, instant message, or via other communication methods. In some implementations, the gift presentation and delivery system 106 may send a notification notifying the gift recipient of the availability of a gift container. In such implementations, the notification may include a link to the gift container. The link may be configured to launch an applet or an application or may direct the gift recipient to a website.

At step 412, the gift presentation and delivery system provides a user interface to the gift recipient for accessing the gift presentation. In some implementations, the gift presentation and delivery system provides the user interface responsive to the gift recipient receiving the gift container or a notification indicating the availability of the gift container. In some implementations, the gift presentation and delivery system may provide the user interface once certain conditions have been satisfied. For example, the gift sender may set a condition to present the gift presentation only at a specific location at a set time or only if the gift sender is connected to the gift presentation and delivery system. The gift presentation and delivery system may be configured to provide the user interface on any computing device associated with the gift recipient. In such implementations, the gift presentation may be device agnostic, or in other words, may be presented to the gift recipient on any type of computing device, including but not limited to desktops, laptops, phones, smartphones, tablets, etc. In such implementations, the gift presentation and delivery system 106 may be able to determine the type of computing device being used by the gift recipient and present a gift presentation in a format that is configured for the particular computing device. In some implementations, the gift presentation may be device-specific. In such implementations, the gift presentation and delivery system may only present the gift presentation if the gift recipient is using a compatible computing device. In some implementations, the gift presentation and delivery system 106 may cause the gift recipient to install particular software or an application in order to access the gift presentation.

At step 414, the gift presentation and delivery system determines if conditions to access the gift have been satisfied. In some implementations, the gift sender may define one or more conditions that have to be satisfied before the gift can be made available to the gift recipient. These conditions may be event-based or activity-based conditions. To determine if conditions have been satisfied, the gift presentation and delivery system may monitor events and/or activity to identify if a pre-defined condition has been satisfied. In some implementations, the gift presentation and delivery system may prompt the gift recipient to perform a particular action.

Once the gift presentation and delivery system determines that one or more of the conditions have been satisfied at step 416 the gift presentation and delivery system 106 provides the gift recipient access to the gift. In some implementations, this may include allowing the gift recipient to take actions on the digital gift. Examples of actions include viewing the gift, downloading the gift, printing an instance of the digital gift, redeeming the gift, amongst others. In some implementations, this may include revealing the gift to the gift sender.

FIG. 5A shows an example work flow of data between parties of the environment associated with FIG. 1. In some implementations, the gift provider provides, to the gift sender, a webpage including one or more gifts from which the gift sender can select a gift. The gift sender submits a response selecting a gift. In some implementations, the gift provider provides a payment user interface to the gift sender. In some implementations, the gift provider may send a gift presentation user interface through which the gift sender can select whether to send the gift with a gift presentation. In such implementations, the payment user interface can be provided before or after the gift presentation page is provided. The gift sender then submits payment information. The gift provider confirms the payment and notifies the gift sender that payment has been confirmed. In some implementations, the gift provider then communicates with the gift presentation and delivery system to create a presentation user interface for the purchased gift. The presentation interface is then presented to the gift sender, who then creates the gift presentation and submits the gift presentation to the gift presentation and delivery system. A gift interface is then created that includes the gift presentation created by the gift sender. The gift page is then delivered to the gift recipient from any one of the gift sender, the gift provider or the gift presentation and delivery system.

In some implementations, the gift selection and payment system are bundled with the gift presentation and delivery system, i.e.—the payment user interface and gift presentation and delivery system user interface are embedded into a gift provider's website as a single plug-in.

In some implementations, the gift provider can communicate with the gift presentation and delivery system through an application programming interface. The gift provider can present a user interface to the gift sender, through which the gift sender can communicate with the gift presentation and delivery system. The user interface can be an embedded widget on the gift provider's website, or in a new tab or window on a separate webpage. The user interface can be configured to allow a customer of the gift provider to select a gift wrapping option. In some implementations, the wrapping options can include no gift wrapping, gift wrapping through the gift provider (retailer), gift wrapping through the gift presentation and delivery system, amongst others. In some implementations, there may be more than one gift wrapping option through the gift presentation and delivery system to accommodate for different prices and features. In some implementations, the customer can select one or more gift wrapping options via a selection object presented on the user interface. The selection object can take the form of a checkbox, a radio button, a button, or any other form of user input that indicates selection. In some implementations, upon selecting an option to gift wrap a purchase through the gift presentation and delivery system, the gift recipient or customer may be presented with a user interface through which the user can select a type of gift wrap.

In some implementations, the gift provider can provide information collected from the gift recipient via the user interface to the gift presentation and delivery system. For example, the gift provider can provide information associated with the gift sender and the gift recipient. This information can be used for inclusion and handling of the digital gift container that is generated by the gift presentation and delivery system. Examples of information can include names, contact information such as emails, user accounts, and social networking details, amongst others.

In some implementations, the gift provider can include the purchase price of the gift wrap selected by the gift sender to the purchase price of the gift. In some implementations, if the gift recipient selected a gift wrap option to be provided by the gift presentation and delivery system, the gift provider can provide the user interface, on the same web page or a separate web page, and provide a predefined time limit within which the gift sender designs the gift presentation. If the gift sender exceeds the predefined time limit, an option to extend the time limit may be presented. In some other implementations, the gift may be removed from the shopping cart.

In some implementations, the gift sender can include one or more premium objects or services in the gift presentation. In some such implementations, the gift presentation and delivery system can update the purchase price of the gift wrap to include the price of the premium objects or services. In some implementations, the gift presentation and delivery system can provide the updated price to the gift provider.

In some implementations, the gift sender can pay for the gift wrap after a payment of the gift is made. In some implementations, the gift sender can pay for the gift wrap via the gift provider. In some implementations, the gift sender can be routed to another website or webpage. In some implementations, the gift sender can pay for the gift wrap via the gift presentation and delivery system.

FIG. 5B shows another example work flow of data between parties of the environment associated with FIG. 1. In some implementations, the gift provider 104 provides, to the gift sender 102, a webpage including one or more gifts from which the gift sender 102 can select a gift. In addition, the gift provider 104 also can provide on the same webpage or a separate web page, an option to select one or more gift presentations with which to deliver the gift selected by the gift sender 102. In some implementations, the gift provider can determine the total price of the gift and the gift presentation and provide a payment page to the gift sender. The gift sender 102 submits a response selecting a gift and a gift presentation. In addition, the gift sender can either provide payment information or confirm payment information to the gift provider 104. In some implementations, the gift provider 104 provides a payment user interface to the gift sender.

Upon receiving the selection and payment information from the gift sender 102, in some implementations, the gift provider 104 confirms the payment and notifies the gift sender that payment has been confirmed. In some implementations, the gift provider 104 also communicates with the gift presentation and delivery system 106 indicating the gift sender has selected a gift presentation. In some implementations, the gift provider 104 can submit a request requesting the gift presentation and delivery system 106 to provide a user interface to the gift sender 102.

The gift presentation and delivery system 106 processes the request and provides a presentation user interface for the purchased gift to the gift sender 102. Upon receiving access to the presentation user interface, the gift sender creates a new gift presentation or modifies a gift presentation template. The gift sender then confirms the gift presentation. The user interface includes one or more scripts, programs, instructions through which the gift sender and the gift presentation and delivery system communicate.

Once the gift sender 102 confirms the gift presentation, the gift presentation and delivery system 106 process the gift presentation of the gift sender. This includes generating a gift container that includes the gift and the gift presentation, amongst other objects. The gift presentation and delivery system 106 then notifies the gift recipient of the gift according to instructions provided by the gift sender 102. In some implementations, one or more features that the gift sender 102 includes in the gift presentation may be a premium feature, which may cost more than the amount previously presented when the gift sender 102 selected the gift presentation. In some such implementations, the gift presentation and delivery system 106, upon receiving an indication that the gift sender 102 has confirmed the gift presentation, may notify the gift provider 104 of the additional costs. The gift provider 104 may then include the additional costs to the total price of the gift and gift presentation previously provided to the gift sender 102. In some implementations, before the gift sender 102 confirms the gift presentation, the user interface may prompt the gift sender 102 of the additional costs for the one or more features.

FIG. 6A shows an example process flow diagram for online digital gift delivery. FIG. 6A provides various integration methods between the gift provider and the gift presentation and delivery system that allow the gift sender to communicate with the gift presentation and delivery system. A first option 602 includes a checkbox that when selected, presents a pop out screen that includes a user interface provided by the gift presentation and delivery system, through which the gift sender can create a gift presentation. A second option 604 is a button that when selected, launches an applet associated with the gift presentation and delivery system to provide a user interface through which the gift sender can create a gift presentation. A third option 606 includes intercepting a mail being sent from the gift provider to the gift recipient. In this option, the gift presentation and delivery system can retrieve information related to the gift sender, the gift recipient and the gift and provide the gift sender an interface through which the gift sender can create a gift presentation.

In some implementations, the gift provider may provide purchase information of the gift to the gift presentation and delivery system 106. The gift sender may be able to access the gift presentation and delivery system to create the gift presentation once the gift provider passes the gift related information to the gift presentation and delivery system. In some implementations, to ensure security, the gift presentation and delivery system may request the gift sender to provide identification information related to the gift purchase. This may include a unique code. In some implementations, the unique code can be the transaction order number generated by the gift provider or a code generated by the gift presentation and delivery system. The gift sender may be provided the code upon confirming that the gift has been purchased.

FIGS. 6B-C show example screenshots corresponding to the process flow diagram depicted in FIG. 6A. These screenshots allows for customized third-party delivery of items in shopping cart. A checkbox or widget in the gift provider's website can be embedded. In some implementations, these may be available on a shopping cart page prior to a purchase is made. In such implementations, if the gift sender selects to send the gift with a gift presentation, the costs for the gift presentation may be included in the purchase price thereby allowing the gift sender to pay for the gift and the gift presentation in a single transaction.

In some implementations, the widget or button may be available after the gift has been purchased. In such implementations, the gift sender may have to pay for the gift presentation service to the gift provider or the gift presentation and delivery system directly or to the gift presentation and delivery system indirectly via the gift provider. In some implementations, the gift provider calls an API for the gift presentation and delivery system and provides information associated with one or more of the gift, the gift sender and the gift recipient. The gift presentation and delivery system may then return the price for the service and present an interface through which payment can be made directly to the gift presentation and delivery system. Once payment has been completed, the gift presentation and delivery system may present the gift sender with the user interface for creating the gift presentation.

FIGS. 7A-E show example screenshots of a user interface for generating a digital gift presentation. As shown, the gift presentation can be created on a canvas on which different data content objects can be positioned. The data content objects can be pictures, messages, applications, games, images, amongst others. The gift presentation can be stored on a server, which is accessible via a link, an example of which is shown in FIG. 7E.

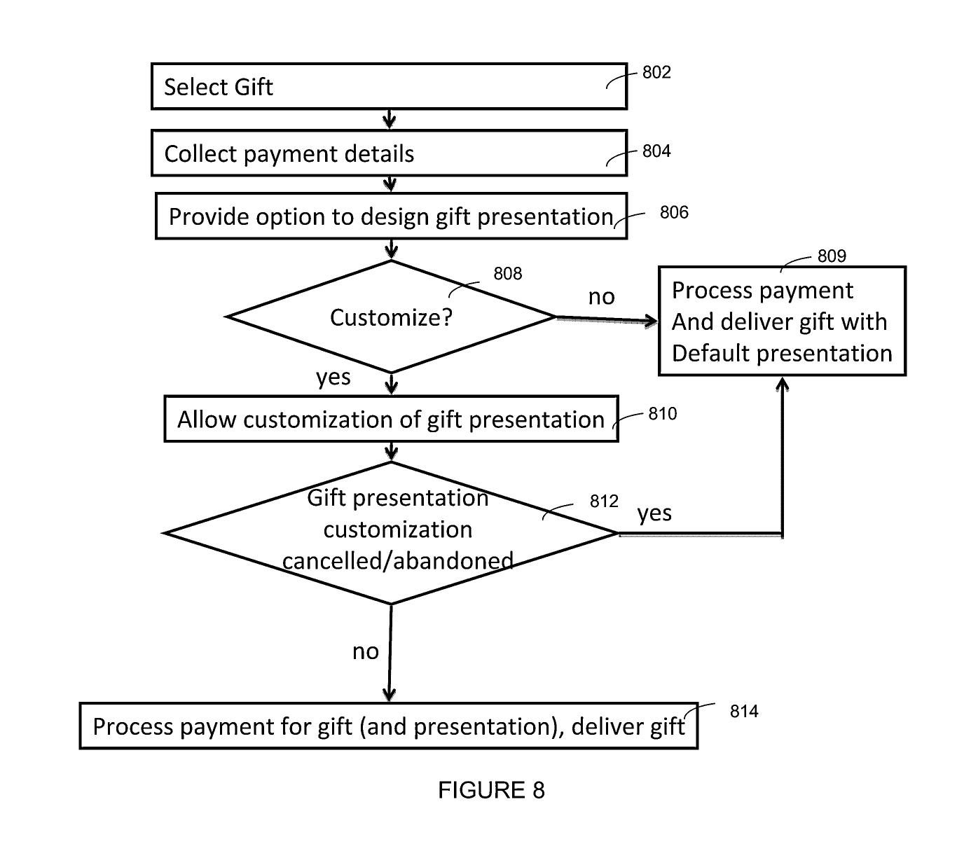

Referring now to FIG. 8, an example flow chart of a process 800 for purchasing and delivering a gift and gift presentation is shown. In brief overview of method 800, at step 802, the gift presentation and delivery system receives a selection of a gift from the gift sender. At step 804, the gift presentation and delivery system receives payment information from the gift sender or another user purchasing the gift. At step 806, the gift presentation and delivery system provides an option to customize the gift presentation being sent to the gift recipient along with the gift. At step 808, the gift presentation and delivery system determines if the gift sender has selected to customize the gift presentation. If the gift sender has selected not to customize the gift presentation, at step 809, the gift presentation and delivery system processes the payment and delivers the gift along with a standard gift presentation to the gift recipient. If the gift sender has selected to customize the gift presentation, at step 810, the gift presentation and delivery system provides a user interface to the gift recipient for customizing the gift presentation. At step 812, the gift presentation and delivery system determines if the customization of the gift presentation has been canceled or abandoned. If the customization of the gift presentation has been canceled or abandoned, the process 800 returns to step 809, where the gift presentation and delivery system processes the payment and delivers the gift along with a standard gift presentation to the gift recipient. If the customization of the gift presentation has been completed instead of being canceled or abandoned, at step 814, the gift presentation and delivery system processes the payment and delivers the gift along with the customized gift presentation to the gift recipient.

In an example implementation, an example method for allowing a gift sender to pre-determine the experience (context and actions) a gift recipient can perform in order to access content provided by the gift sender. Below is a list of example actions the gift recipient can perform to receive a gift in response to a gift presentation created by the gift sender. In some implementations, these actions may be performed to satisfy conditions predefined in the gift presentation.

In some implementations, the gift sender can create or design the gift presentation. The system provides the gift sender a virtual canvas on which the gift sender can express themselves or their emotions, thoughts or feelings, to the gift recipient. The gift sender can do so by including various data content items, such as photographs, music, games, messages, amongst others. Moreover, the gift sender can arrange the data contents in a manner that allows the gift sender to express their emotions when sending a digital gift. The gift sender can create an interactive gift presentation that allows the gift recipient to take actions associated with the gift presentation. In some implementations, the gift presentation may be configured to reveal a gift or the identity of a gift. In some such implementations, the gift presentation may be configured to reveal the gift or the identity of the gift responsive to a gift presentation policy. The gift presentation policy can specify one or more conditions that have to be met or fulfilled such that the gift or the identity of the gift is revealed to the gift recipient. The conditions can include event-based conditions or activity-based conditions. In some implementations, a condition can include a combination of event-based conditions and activity-based conditions, such as performing an action within a particular time frame or at a particular location. In one example, the action can be sliding a picture after 3 seconds of viewing the picture. In some such implementations, the conditions can include actions taken in accordance with instructions provided by the gift sender. Examples of such conditions can include clicking, dragging one or more fingers or a cursor along the screen, making one or more gestures on the screen either via the user's fingers or a cursor, examples of which can include unwrapping a present, tearing, moving an object from one location on the screen to another, scratching a lottery ticket, amongst others. In some implementations, the actions can include recording audio according to predefined patterns and timing. In some implementations, the condition may include recording audio matching recorded audio selected or input by the gift sender.

In some implementations, an action can include dragging an item from the gift sender's screen to the gift recipient's screen to vice versa. In some implementations, an action taken by the gift recipient can affect the gift presentation on the gift sender's screen and vice versa. For example, the gift sender can click an icon, link, or other object, such as a “reveal gift” icon on their screen, which can be received by the server in communication with both the gift recipient and the gift sender, and cause the gift to be revealed on the gift recipient's screen.

In some implementations, the gift presentation can be configured to allow the gift sender and the gift recipient to place a call or video call request to one another, via an object of the gift presentation. This object may be configured to tap into one or more other controls of the computing device on which the gift presentation is accessed. In some implementations, the system can be configured to call an API to a phone service of the computing device to place a call. In some implementations, the object can include a phone number of the person.

In some implementations, the gift sender and gift recipient can interact with one another via the gift presentation. For example, the gift sender and the gift recipient can communicate via messaging, email, or via real-time communications, such as via phone, video, an online chat application or mobile messaging service. In some implementations, the gift sender and gift recipient can play a game against each other, for example, a chess game, a racing game, or any other third-party game. In some implementations, the condition to reveal the gift can be based on a third-party application, such as a third party game. For example, the gift recipient may have to reach a certain score before the gift is revealed. In some implementations, the gift can be associated with the third-party application for which the condition is set. Specifically, in one example, the gift can be a virtual gift associated with the third-party game.

In some implementations, the gift sender can also provide one or more questions to the gift recipient. The questions may be posed in any format, for example, multiple-choice, fill in the blank, select a spot on a map, amongst others. In some implementations, the system can record the gift sender's text inputs as questions and answers and feedback. The system can provide the questions to the gift recipient as well as response objects in which the gift recipient can provide responses to the questions. The system can determine if the gift recipient's response matches the answer provided by the gift sender and if the response matches the answer provided by the gift sender, the system may provide the gift recipient access to the gift. In some implementations, the gift sender may input words via audio or text. The gift recipient may enter the same words via audio or text for the gift to be revealed.

In some implementations, the gift sender can include a condition that prevents the gift recipient from accessing the gift presentation and/or revealing the gift. For example, the gift sender can include a condition in which the gift presentation is presented to the gift sender in the presence of another person, for example, the gift recipient themselves. In some implementations, the system may provide an authentication object to authenticate whether the other person is with the gift recipient. In some implementations, the authentication means can include entering a password, voice, facial or fingerprint recognition, signing into an account, such as a social networking account, amongst others.

As previously described above, the gift sender can design the gift presentation. In some implementations, the gift sender can provide a gift or an indication of the gift to the gift presentation and delivery system. In some implementations, the gift can be provided via the gift provider directly to the gift presentation and delivery system. The gift sender can select a gift presentation template or create a new gift presentation from a blank canvas. The gift sender can customize the gift presentation that are used to design a webpage or GUIs through which the gift recipient can interact with in order to access the gift.

In some implementations, that includes setting the arrangement of the data content. The gift delivery and presentation system can be configured to allow the gift sender to upload pictures, video, audio, messages, games, other software constructs as well as insert text or other images. The gift sender can further be allowed to stylize and arrange the content in desired manner. The gift sender can select to place a data content item at a particular location on the user interface. The gift delivery and presentation system can store the coordinates of the data content item. In some implementations, the gift sender can select to cause the data content items to move in one or more directions and in one or more ways, for example, swirling, rotating, amongst others. The gift sender can also be allowed to modify the content by cropping, resizing, controlling the color or opacity settings, or adding text or drawings, among other possibilities. In addition, the gift sender can be allowed to structure the sequence in which the data content items are displayed to provide the gift recipient with an experience in the form of a narrative or storyboard.

Furthermore, the gift sender can be allowed to define or set conditions that the gift recipient may have to perform in order to access content. Examples of some such conditions include the pattern, number, and location of clicks, taps, drags or multi-touch gestures. In some such implementations, the gift presentation and delivery system can provide a user interface that provides a recording option. The gift sender can record one or more actions being performed via the user interface and set them as conditions. In some implementations, the gift presentation and delivery system can record single and multi-touch gestures performed by the gift sender and set such gestures as conditions. The gift presentation and delivery system can also include a margin of error for each gesture, such that if the gift recipient performs gestures similar to the conditions, the gift presentation and delivery system can determine that the gift recipient has fulfilled the condition.

In some implementations, the gift sender can also set one or more conditions that if met, reveal the identity of the gift to the gift recipient. As described above, one or more of the following event-based conditions or activity-based conditions can be predefined in the gift presentation. Examples of conditions can be based on one or more physical actions. Examples of such actions can include drawing, touch-based gestures in a set pattern, for example, to view a story or play a game, moving data content items, such as photos, or simulated physical objects, to reveal a gift concealed by the physical objects. In some implementations, the presentation could mimic a real story within the user interface, in which the user can enter doors, move to different rooms, amongst others. In some implementations, the gift sender can also control when the gift recipient can have access to the gift presentation. In some implementations, the gift sender can initiate the gift presentation on the gift recipient's device.

In some implementations, the gift sender can define conditions that involve the action of users, including but not limited to the gift recipient. Examples of such conditions include the proximity of two user devices or performing actions that require simultaneous or sequential interaction on multiple user devices. One example includes a condition that requires a puzzle or maze to be solved together.

In some implementations, the gift sender can define conditions that involve the interaction with the environment. For example, a condition may require the gift recipient to visit one or more geographic locations, perhaps in an order of sequence. Other conditions can include using external sensors, such as weather based sensors, a compass, or an accelerometer of the user device, for example to detect the user device being shaken.

In some implementations, one condition can precede a second condition. In this way, the gift sender can define an order in which certain conditions are to be met. In some implementations, the gift sender can string together multiple interactive presentations that the gift recipient progresses through in a sequence determined by the gift sender.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method for online digital gift delivery comprising,
receiving, by a device, from a gift sender a request to deliver a digital gift to a gift recipient;
responsive to instructions received from the gift sender via a user interface provided to the gift sender responsive to receiving the request, generating, by the device, a digital gift container including a digital gift presentation and an indication of the digital gift, the digital gift presentation configured to display an arrangement of data content objects and configured to reveal the indication of the digital gift responsive to a gift presentation policy specifying one or more conditions for revealing the indication;
providing the gift recipient access to the digital gift container; and
revealing, via the digital gift container, the indication of the digital gift responsive to determining that one or more conditions of the gift presentation policy have been met.

2. The method of claim 1, wherein revealing the indication of the digital gift comprises providing the digital gift.

3. The method of claim 1, wherein generating a digital gift container further comprises generating the digital gift presentation.

4. The method of claim 1, wherein providing the gift recipient access to the digital gift container comprises providing the digital gift container to the gift recipient.

5. The method of claim 1, wherein providing the gift recipient access to the digital gift container comprises providing a link to the digital gift container to the gift recipient and responsive to the gift recipient accessing the link, providing the gift recipient a user interface that presents the digital gift presentation to the user.

6. The method of claim 1, wherein the gift presentation policy specifies at least one of an event-based condition or an activity-based condition, the event-based condition configured to be met when a particular event occurs and the activity-based condition configured to be met when a particular action is performed.

7. The method of claim 1, wherein determining that one or more conditions of the gift presentation policy have been met comprises determining, by the device, that an event-based condition has been met.

8. The method of claim 1, wherein determining that one or more conditions of the gift presentation policy have been met comprises receiving from the gift recipient, an indication of an action that matches an action listed as a condition of the gift presentation policy.

9. The method of claim 1, wherein providing the gift recipient access to the digital gift container comprises providing the gift recipient access to the digital gift container responsive to receiving a request to access the digital gift container from a user device of the gift recipient.

10. The method of claim 1, further comprising:
identifying a device type of the user device through which the gift recipient is requesting access;
formatting the digital gift container to a format compatible for display with the user device; and
providing the gift recipient access to the formatted digital gift container.

11. The method of claim 1, further comprising:
identifying at least one action of the gift recipient responsive to providing the indication of the digital gift;
identifying the action as an indication of approval of the digital gift; and
responsive to identifying the action as an indication of approval, providing suggestions of digital gifts similar to the digital gift to one or more gift senders seeking to send a digital gift to the gift recipient.

12. The method of claim 1, wherein receiving, by a device, from a gift sender a request to deliver a digital gift to a gift recipient comprises receiving the request to deliver the digital gift via a digital gift provider interfacing between the gift sender and the device.

13. The method of claim 1, wherein the gift presentation policy includes one or more conditions defined by the gift sender.

14. A digital gift presentation system comprising:
a digital gift presentation device configured to
receive from a gift sender a request to deliver a digital gift to a gift recipient;
responsive to instructions received from the gift sender via a user interface provided, by the device, to the gift sender, generate a digital gift container including an indication of the digital gift and a digital gift presentation, the digital gift presentation configured to reveal the indication of the digital gift responsive to a gift presentation policy specifying one or more conditions for revealing the indication;
provide the gift recipient access to the digital gift container; and
reveal the indication of the digital gift responsive to determining that one or more conditions of the gift presentation policy have been met.

15. The system of claim 14, wherein the gift presentation policy specifies at least one of an event-based condition or an activity-based condition, the event-based condition configured to be met when a particular event occurs and the activity-based condition configured to be met when a particular action is performed.

16. The system of claim 14, wherein the gift presentation policy includes one or more conditions defined by the gift sender.

17. The system of claim 14, wherein the device is further configured to:
identify a device type of the user device through which the gift recipient is requesting access;
format the digital gift container to a format compatible for display with the user device; and
provide the gift recipient access to the formatted digital gift container.

18. The system of claim 14, wherein the device is configured to receive a request to deliver a digital gift to a gift recipient via a digital gift provider interfacing between the gift sender and the device.

19. A method for online digital gift delivery comprising,
receiving, by a device, from a gift sender a request to deliver a digital gift to a gift recipient;
responsive to instructions received from the gift sender via a user interface provided to the gift sender responsive to receiving the request, generating, by the device, a digital gift container including a digital gift presentation and an indication of the digital gift, the interactive digital gift presentation configured to
i) be displayed as an arrangement of data content objects,
ii) respond to one or more actions taken on the data content objects by the gift recipient, and
iii) reveal the indication of the digital gift responsive to a gift presentation policy specifying one or more conditions for revealing the indication, the gift presentation policy being defined by the gift sender;
providing the gift recipient access to the digital gift container; and
revealing, via the digital gift container, the indication of the digital gift responsive to determining that one or more conditions of the gift presentation policy have been met.

20. The method of claim 19, further comprising:
identifying a device type of the user device through which the gift recipient is requesting access;
formatting the digital gift container to a format compatible for display with the user device; and
providing the gift recipient access to the formatted digital gift container.
